(19) United States
(12) Patent Application Publication
(10) Pub. No.: US 2025/0143844 A1
(43) Pub. Date: May 8, 2025

(54) DEVICES AND METHODS FOR POSITIONING DENTAL AUXILIARIES ON TEETH

(71) Applicant: Align Technology, Inc., San Jose, CA (US)

(72) Inventors: Crystal Tjhia, Sunnyvale, CA (US); Zahra Fahim Nia, San Jose, CA (US); Jivtesh Khurana, San Francisco, CA (US); Sudharshan Anandan, Sunnyvale, CA (US); Jessica H. Schiltz, San Jose, CA (US); Viswanath Meenakshisundaram, Santa Clara, CA (US); Chang Xu, Milpitas, CA (US); Shaoming Wang, Cary, NC (US); Simone Rossi, Durham, NC (US); Laura Natania Nicole Marina Lee, Knightdale, NC (US); Fred Ting, San Jose, CA (US); Dmitry B. Sirotkin, Moscow (RU); Christopher Carner, Apex, NC (US); Lana Tran, San Jose, CA (US); Kangning Su, Pullman, WA (US); Nilesh Joshi, Cary, NC (US); Yuxiang Wang, Newark, CA (US); Bastien Pesenti, San Jose, CA (US); Joel Anderson, Raleigh, NC (US); Stuart Macrae Montgomery, San Jose, CA (US)

(21) Appl. No.: 18/935,286

(22) Filed: Nov. 1, 2024

Related U.S. Application Data
(60) Provisional application No. 63/595,651, filed on Nov. 2, 2023.

(51) Int. Cl. A61C 7/02; A61C 13/34

(52) U.S. Cl. CPC A61C 7/02; A61C 13/34

(57) ABSTRACT

Devices, methods, and systems for placing dental auxiliaries on teeth are provided. In some embodiments, for example, a dental auxiliary positioner for placing a dental auxiliary on a tooth includes: a registration element configured to receive a patient's tooth; and an auxiliary support coupled to the registration element and further coupled to an auxiliary, where the auxiliary support is configured to position the auxiliary against a surface of the tooth, and where the auxiliary support includes a frame extending at least partially around the auxiliary, one or more struts coupling the auxiliary to the frame, and a flexible bridge coupling the frame to the registration element, where the flexible bridge is configured to bend in one or more directions relative to the tooth to adjust the position of the auxiliary on the surface of the tooth.

### CROSS-REFERENCE TO RELATED APPLICATION(S)

The present application claims the benefit of priority to U.S. Provisional Application No. 63/595,651, filed Nov. 2, 2023, which is incorporated by reference herein in its entirety.

### TECHNICAL FIELD

The present technology generally relates to dental and orthodontic treatment procedures, and in particular, to devices and methods for positioning dental auxiliaries on teeth.

### BACKGROUND

Dental appliances are used to treat various dental conditions, such as dental malocclusions, jaw dysfunction/misalignment, functional and/or aesthetic conditions, endodontic conditions, and others. For example, a patient's teeth can be repositioned using a series of dental appliances that are placed successively on the teeth to provide controlled forces to gradually move the teeth toward a desired arrangement. Some treatment procedures use one or more attachments that are bonded to the patient's teeth at specific locations to interact with a dental appliance to impart repositioning forces on the teeth. A template may be used to position the attachments at the appropriate locations on the teeth for bonding. However, conventional templates are generally rigid devices, which may make it challenging for the clinician to apply the attachments to the correct locations on the teeth during the bonding process if the template geometry does not sufficiently match the geometry of the patient's teeth (e.g., due to inaccuracies and/or variability in manufacturing).

Moreover, certain dental conditions may make it challenging or impossible to position attachments on teeth using conventional templates. For instance, a particular tooth may be made inaccessible by other teeth (e.g., due to crowding, later-erupting teeth, surrounding teeth that erupted prior to the particular tooth in the case where the particular tooth has not fully erupted) and/or by other objects in the intraoral cavity (e.g., other dental appliances), such that there is insufficient space to position an attachment on the tooth with a conventional template. Such teeth may also be inaccessible to conventional dental tools that are used to bond attachments to teeth.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a perspective view of a patient's teeth with dental auxiliaries, in accordance with embodiments of the present technology.

FIG. 1B is a perspective view of a dental auxiliary positioner on the patient's teeth of FIG. 1A, in accordance with embodiments of the present technology.

FIG. 2 is a perspective view of a dental arch including a tooth that is made inaccessible by one or more neighboring teeth.

FIG. 3A is a partially schematic perspective view of a portion of a dental auxiliary positioner for placing an auxiliary on a lingual surface of a tooth, in accordance with embodiments of the present technology.

FIG. 3B is a partially schematic perspective view of a portion of a dental auxiliary positioner for placing a first auxiliary on a lingual surface of a tooth and a second auxiliary on a buccal surface of the tooth, in accordance with embodiments of the present technology.

FIG. 4A is a partially schematic top view of a dental auxiliary positioner with a connector for positioning an auxiliary on a target tooth, in accordance with embodiments of the present technology.

FIG. 4B is a partially schematic perspective view of a portion of the dental auxiliary positioner of FIG. 4A on a patient's teeth, in accordance with embodiments of the present technology.

FIG. 5A is a partially schematic perspective view of a portion of a dental auxiliary positioner with a discrete auxiliary support for placing an auxiliary on a tooth, in accordance with embodiments of the present technology.

FIG. 5B is a partially schematic perspective view of the auxiliary support of FIG. 5A, in accordance with embodiments of the present technology.

FIG. 6 is a partially schematic perspective view of a portion of a dental auxiliary positioner with an adjustable auxiliary support for placing an attachment on a tooth, in accordance with embodiments of the present technology.

FIG. 7A illustrates initial designs for a first auxiliary support and a second auxiliary support.

FIG. 7B illustrates modified designs for the first auxiliary support and the second auxiliary support of FIG. 7A, in accordance with embodiments of the present technology.

FIG. 8A illustrates an initial design for an auxiliary support.

FIG. 8B illustrates a modified design for the auxiliary support of FIG. 8A, in accordance with embodiments of the present technology.

FIG. 8C illustrates another modified design for the auxiliary support of FIG. 8A, in accordance with embodiments of the present technology.

FIG. 9A is a front view of a portion of a dental auxiliary positioner including an auxiliary support configured to reduce debris, in accordance with embodiments of the present technology.

FIG. 9B is a perspective view of a portion of a dental auxiliary positioner including a frameless auxiliary support to reduce debris, in accordance with embodiments of the present technology.

FIG. 9C is a perspective view of a portion of a dental auxiliary positioner including interconnected auxiliary supports to reduce debris, in accordance with embodiments of the present technology.

FIG. 10A is a perspective view of a dental auxiliary positioner for placing an auxiliary on a single tooth, in accordance with embodiments of the present technology.

FIG. 10B is a perspective view of another dental auxiliary positioner for placing an auxiliary on a single tooth, in accordance with embodiments of the present technology.

FIG. 10C is a perspective view of yet another dental auxiliary positioner for placing an auxiliary on a single tooth, in accordance with embodiments of the present technology.

FIG. 10D is a perspective view of another dental auxiliary positioner for placing an auxiliary on a single tooth, in accordance with embodiments of the present technology.

FIG. 11 is a flow diagram illustrating a method for designing a dental auxiliary positioner for placing a dental auxiliary on a tooth, in accordance with embodiments of the present technology.

FIG. 12 is a flow diagram illustrating a method for designing a dental auxiliary positioner for placing a dental auxiliary on a tooth, in accordance with embodiments of the present technology.

FIG. 13A illustrates a process for mounting an auxiliary to a tooth using an energy applicator, in accordance with embodiments of the present technology.

FIG. 13B illustrates a tooth arrangement in which access to an auxiliary is obstructed.

FIG. 14A is a partially schematic top view of a moldable material applied to an auxiliary on a tooth, in accordance with embodiments of the present technology.

FIG. 14B is a partially schematic side view of the moldable material of FIG. 14A applied to an auxiliary on a tooth, in accordance with embodiments of the present technology.

FIG. 14C is a partially schematic front view of the moldable material of FIG. 14C applied to an auxiliary on a tooth, in accordance with embodiments of the present technology.

FIG. 15 is a flow diagram illustrating a method for placing a dental auxiliary on a tooth, in accordance with embodiments of the present technology.

FIG. 16 is a perspective view of a device including a dental auxiliary and an integrated interface for an energy applicator, in accordance with embodiments of the present technology.

FIG. 17A is a side view of a portion of a dental auxiliary positioner including flexible auxiliary supports, in accordance with embodiments of the present technology.

FIG. 17B is a perspective view of an individual auxiliary support of the positioner of FIG. 17A, in accordance with embodiments of the present technology.

FIG. 17C is a side view of a portion of a dental auxiliary positioner including flexible auxiliary supports, in accordance with embodiments of the present technology.

FIG. 17D is a perspective view of an individual auxiliary support of the positioner of FIG. 17C, in accordance with embodiments of the present technology.

FIG. 18A illustrates removal of a dental auxiliary positioner from a patient's teeth, in accordance with embodiments of the present technology.

FIG. 18B is a partially schematic illustration of struts coupled to an auxiliary at a positive angle, in accordance with embodiments of the present technology.

FIG. 18C is a partially schematic illustration of struts coupled to an auxiliary at a negative angle, in accordance with embodiments of the present technology.

FIG. 18D is a partially schematic illustration of stresses applied to a buccal auxiliary support during positioner removal, in accordance with embodiments of the present technology.

FIG. 18E is a partially schematic illustration of stresses applied to a lingual auxiliary support during positioner removal, in accordance with embodiments of the present technology.

FIG. 19 is a flow diagram illustrating a method for placing a dental auxiliary on a patient's tooth, in accordance with embodiments of the present technology.

FIG. 20A illustrates a representative example of a tooth repositioning appliance configured in accordance with embodiments of the present technology.

FIG. 20B illustrates a tooth repositioning system including a plurality of appliances, in accordance with embodiments of the present technology.

FIG. 20C illustrates a method of orthodontic treatment using a plurality of appliances, in accordance with embodiments of the present technology.

FIG. 21 illustrates a method for designing an orthodontic appliance, in accordance with embodiments of the present technology.

FIG. 22 illustrates a method for digitally planning an orthodontic treatment and/or design or fabrication of an appliance, in accordance with embodiments of the present technology.

### DETAILED DESCRIPTION

The present technology relates to devices and methods for positioning dental auxiliaries or appliances on a patient's teeth, such as dental attachments, buttons, power arms, brackets, splints, distalizers, wires, etc. In some embodiments, for example, a dental auxiliary positioner of the present technology includes a registration element configured to receive a patient's tooth, and an auxiliary support that is coupled to an auxiliary to position the auxiliary at a predetermined location on the tooth. The auxiliary support can include a frame extending at least partially around the auxiliary, one or more struts coupling the auxiliary to the frame, and a flexible bridge coupling the frame to the registration element. For example, the flexible bridge can be a straight or curved elongate shaft that is bendable in one or more directions relative to the tooth (e.g., a buccal-lingual direction, a mesial-distal direction) to adjust the position of the auxiliary on the surface of the tooth.

As used herein, the term “inaccessible tooth (or teeth)” includes a particular tooth (or teeth) that is inaccessible or at least difficult to access when positioning, bonding, or otherwise manipulating an auxiliary on that particular tooth because of surrounding objects (e.g., other teeth, soft tissue in the intraoral cavity, another auxiliary on the particular tooth or a different tooth, another portion of the auxiliary positioner, another dental appliance, etc.) or because of the particular tooth's location within the oral cavity (e.g., being positioned out of reach of a bonding tool such as an energy applicator). In some embodiments, the disclosed positioner is configured to allow for accurate placement and secure bonding of auxiliaries on many cases of inaccessible teeth. For instance, the positioner can include features such as connectors that provide additional flexibility in placement of auxiliaries on teeth. As another example, the features of the auxiliary support can be modified (e.g., trimmed, reshaped) to accommodate other objects that render the teeth inaccessible. Modifications can alternatively or additionally be made to provide other benefits, such as reducing debris produced when releasing the auxiliary from the positioner.

In some embodiments, the present technology provides materials and devices that are used to interface between an auxiliary on a tooth and an energy applicator used to bond the auxiliary to the tooth. For example, a moldable material can be applied to the auxiliary to allow energy and/or pressure from the energy applicator to be transmitted onto the auxiliary to facilitate securing bonding to the tooth. Optionally, the auxiliary can be provided with an integrated applicator interface that allows transmission of energy and/or pressure onto the auxiliary. This approach can be advantageous if the tooth is blocked or otherwise made inaccessible in a manner that makes it difficult or impossible to directly reach the auxiliary with the energy applicator.

The present technology can provide many advantages compared to conventional devices and methods for placing auxiliaries on teeth. For instance, placement and bonding of auxiliaries on inaccessible teeth via conventional approaches may be challenging due to difficulties in visualizing the bonding site, difficulties in reaching the bonding site, and/or difficulties in introducing tools to the bonding site. Moreover, correct placement of the auxiliary may be compromised if the positioner does not fit properly on the teeth. Such fit errors may arise, for example, if the geometry of the positioner does not sufficiently match the geometry of the teeth (e.g., due to inaccuracies during scanning of the teeth, positioner design, and/or positioner manufacturing). Fit errors may also arise when designing positioners for teeth that are crowded or otherwise severely maloccluded, since it may be difficult to ensure that the positioner fits tightly on the teeth surfaces. Poor auxiliary placement may result in deficient bonding between the auxiliary and the tooth surface, e.g., the strength of the bond may be weakened if there is insufficient contact between the auxiliary and the tooth, there may be gaps between the bonded auxiliary and the tooth surface, etc. Moreover, poor auxiliary placement can interfere with therapeutic efficacy and/or patient compliance, e.g., insufficient and/or incorrect forces may be applied to the teeth, it may be difficult to seat the dental appliance properly on the teeth, the auxiliary may become dislodged during treatment, etc.

To overcome these and other challenges, the present technology provides dental auxiliary positioners having auxiliary supports with tunable flexibility to allow for adjustments to the position of the auxiliary on the tooth surface. Such adjustments can be made, for example, to ensure that the auxiliary is placed at the correct location (e.g., if fit errors are present) and/or to ensure sufficient contact between the auxiliary and the tooth surface during bonding. The design of the dental auxiliary positioner can also include features to allow for placement of auxiliaries on inaccessible teeth. Moreover, the dental auxiliary positioner can include features to allow the auxiliary to be quickly and easily released from the rest of the positioner after bonding (e.g., by controlled fracturing of the auxiliary support), without creating loose debris that may pose a choking hazard or otherwise detract from the overall user experience. Such dental auxiliary positioners may also be more durable for manufacturing, handling, processing, and shipping.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Dental Auxiliary Positioners and Associated Methods and Devices

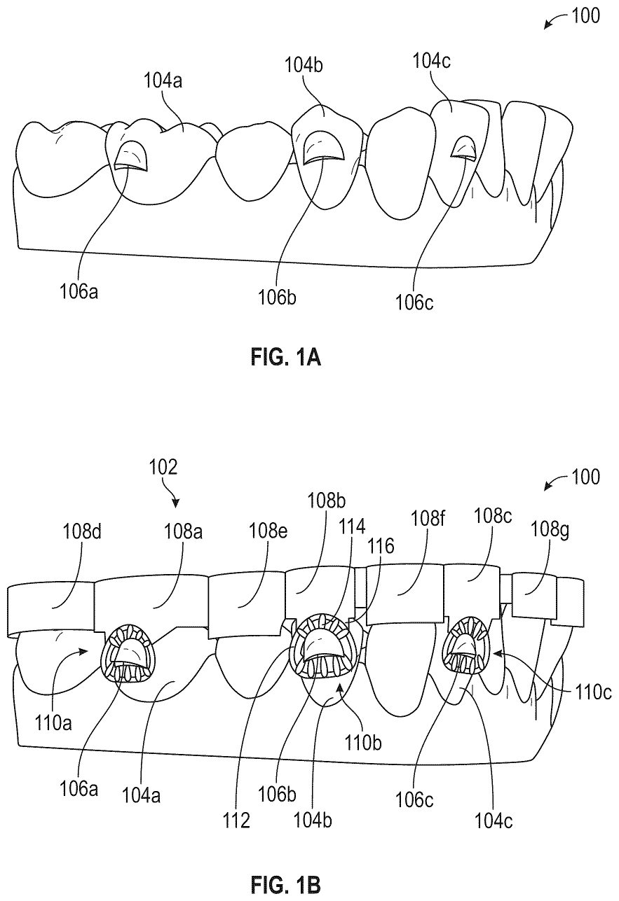

FIG. 1A is a perspective view of a patient's teeth 100, and FIG. 1B is a perspective view of a dental auxiliary positioner (“positioner 102”) on the teeth 100, in accordance with embodiments of the present technology. Referring first to FIG. 1A, the teeth 100 can include one or more teeth (e.g., a first tooth 104a, a second tooth 104b, and a third tooth 104c-collectively, “teeth 104”) having respective auxiliaries mounted thereon (e.g., a first auxiliary 106a, a second auxiliary 106b, and a third auxiliary 106c-collectively, “auxiliaries 106”). In some embodiments, the auxiliaries 106 are bonded to the teeth 104 using an adhesive, such as a curable adhesive (e.g., a UV-curable adhesive). An “auxiliary” or “dental auxiliary” can be any object that is affixed to one or more teeth and that is designed to engage a dental appliance (e.g., an aligner, attachment template, palatal expander, retainer, mouth guard) to facilitate an orthodontic treatment or to maintain/protect teeth, such as dental attachments, buttons, power arms, brackets, splints, distalizers, wires, etc. In the illustrated embodiment, for example, the auxiliaries 106 are attachments that engage respective portions of a dental appliance (not shown) to produce forces for repositioning the teeth 104. Auxiliaries may be placed on the lingual, buccal, and/or occlusal surfaces of one or more teeth. As used herein, the term “occlusal auxiliary” includes occlusal blocks, bite ramps, attachments, or any other suitable projecting element placed on an occlusal side of a tooth for the purpose of, e.g., spacing apart or disoccluding teeth of the upper and lower jaw. For example, an occlusal auxiliary may be an occlusal block placed along one or more posterior teeth (and/or anterior teeth) so as to disocclude teeth for allowing jaw movement (e.g., anterior or posterior jaw movement) to correct, e.g., an underbite, an overbite, a crossbite, etc.

Referring next to FIG. 1B, the positioner 102 can be used to place the auxiliaries 106 at predetermined locations on the teeth 104 so that the auxiliaries 106 engage properly with the dental appliance. In some embodiments, the positioner 102 includes a plurality of registration elements 108a-108g (collectively, “registration elements 108”) that are configured to receive the teeth 100. A registration element 108 may receive a tooth by, for example, receiving and/or extending over only a portion of the tooth, such as the crown of the tooth, a portion of the tooth proximate to the crown, a buccal portion of an occlusal surface of the tooth, etc. The registration elements 108 can be connected to each other via rigid or flexible couplings to form a unitary appliance body. Each registration element 108 is configured to receive and engage a corresponding tooth to retain the positioner 102 in a specified spatial configuration with respect to the teeth 100. For instance, each registration element 108 can include a cavity formed therein to define an inner surface that engages a corresponding surface of the received tooth (e.g., the occlusal, buccal, and/or lingual surface of the tooth).

The positioner 102 includes one or more auxiliary supports (e.g., a first auxiliary support 110a, a second auxiliary support 110b, and a third auxiliary support 110c-collectively, “auxiliary supports 110”) that are each configured to position a corresponding auxiliary 106 at a predetermined location against or proximate to a surface of a tooth 104 when the positioner 102 is placed on the patient's teeth 100. In the illustrated embodiment, each auxiliary support 110 is coupled to a corresponding registration element 108 that receives the tooth 104 to which the auxiliary 106 is to be mounted, such that when the registration element 108 engages the tooth 104, the auxiliary 106 is positioned at a predetermined location on the tooth 104. Optionally, the registration element 108 can be coupled to a retention support (not shown) that engages another portion of the received tooth 104 (e.g., the lingual surface when the auxiliary is to be placed on the buccal side, the buccal surface when the auxiliary is to be placed on the lingual side, an interproximal region, and/or an undercut region) to produce a force that biases or maintains the auxiliary support 110 toward/against the tooth 104 to stabilize the positioner 102 and/or to facilitate positioning of the auxiliary 106 against the surface of the tooth 104.

In the illustrated embodiment, the auxiliary support 110 includes a frame 112 that extends partially or entirely around a perimeter of the auxiliary 106, e.g., to protect/stabilize the auxiliary 106 during manufacturing, shipment, and/or handling. The frame 112 can be coupled directly to the registration element 108, or can be coupled indirectly via a bridge 116 (also known as a “frame belt”). The bridge 116 can be flexible to permit some movement of the frame 112 and auxiliary 106 relative to the corresponding registration element 108, or can be rigid so that the frame 112 and auxiliary 106 are maintained in a fixed spatial relationship with respect to the corresponding registration element 108.

The auxiliary 106 can be coupled to the frame 112 via a plurality of struts 114. Each strut 114 can be an elongate member including a first end connected to the frame 112 and a second end connected to the auxiliary 106. The struts 114 can be distributed around the perimeter of the auxiliary 106. In the illustrated embodiment, for example, the auxiliary support 110 includes a first set of struts 114 at a first (e.g., gingival) side of the auxiliary 106, and a second of struts 114 at a second (e.g., occlusal) side of the auxiliary 106. In some embodiments, the struts 114 are breakable components that are fractured to release the auxiliary 106 from the positioner 102 after the auxiliary 106 has been bonded to the tooth 104, thus allowing the positioner 102 to be removed while the bonded auxiliary 106 remains in place on the tooth 104.

The auxiliaries 106 can be prefabricated components that are manufactured together with the auxiliary supports 110 and registration elements 108, such that each auxiliary 106 is integrally formed with its respective frame 112 and struts 114. In some embodiments, the entire positioner 102, including the auxiliaries 106, auxiliary supports 110, and registration elements 108, is fabricated in a single manufacturing operation (e.g., via a single additive manufacturing process). Alternatively, some portions of the positioner 102 can be discrete components that are fabricated separately (e.g., via separate additive manufacturing processes) and subsequently assembled to form the positioner 102, e.g., the auxiliary supports 110 and auxiliaries 106 can be fabricated in a different manufacturing operation than the registration elements 108.

In some embodiments, the dental auxiliary positioners disclosed herein are configured to place auxiliaries on inaccessible teeth. A tooth may be inaccessible due to other teeth, other portions of the same dental auxiliary positioner (e.g., another auxiliary support and/or registration element on the dental auxiliary positioner), and/or another auxiliary that is already mounted on or is intended to be mounted on the teeth (e.g., buttons, attachments, brackets, power arms, splints, distalizers, wires, etc.). A tooth can be considered to be inaccessible if there is not enough space to place an auxiliary on a surface of the tooth (e.g., on the buccal surface), there is not enough space to fit an auxiliary support proximate to the tooth, there is not enough space to fit a registration element on the crown of the tooth, and/or there is not enough space to fit an energy applicator (e.g., a curing wand) against the auxiliary to bond the auxiliary to the tooth. Inaccessibility may be evaluated based on the distance between a tooth and the arch curve of the patient's dentition, and/or based on the amount of overlap between a tooth and one or more neighboring teeth.

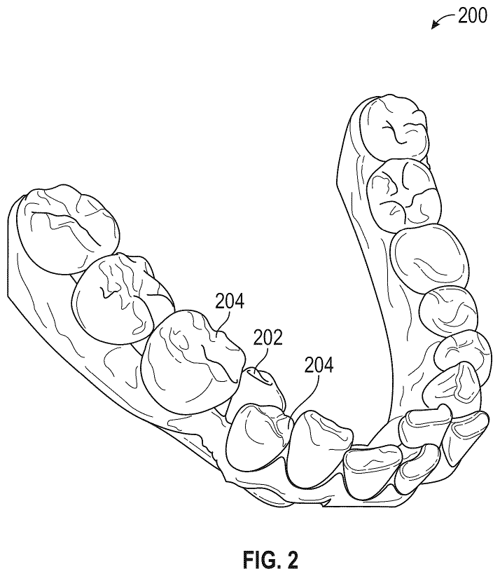

For example, FIG. 2 is a perspective view of a dental arch 200 including a tooth surface 202 that is made inaccessible by one or more neighboring teeth 204. As shown in FIG. 2, the neighboring teeth 204 block a portion of the buccal surface of the tooth 202, such that it may be difficult or impossible to place an auxiliary on the surface of the tooth 202 using conventional devices. Impeded access can also occur for lingual and occlusal tooth surfaces. For instance, there may be insufficient unobstructed surface area on the surface of the tooth 202 to position an auxiliary, registration element, and/or auxiliary support, and/or the positioning of the neighboring teeth 204 can prevent the ability to successfully bond the auxiliary with dental instruments (e.g., light curing wands). Such situations can arise, for example, due to malocclusions, crowding (e.g., in patients with small arches such as children), late-erupting teeth (e.g., canines often erupt after the lateral incisors and may cover up the lateral incisors), and/or a case where a particular erupting tooth is blocked by surrounding teeth that erupted earlier. Moreover, if auxiliaries are to be placed on the neighboring teeth 204 as well, the registration elements and/or auxiliary supports for those teeth 204 may also block placement of an auxiliary on the tooth 202. Likewise, if the tooth already has an auxiliary bonded to it, that auxiliary may make it difficult to access the tooth to place another auxiliary.

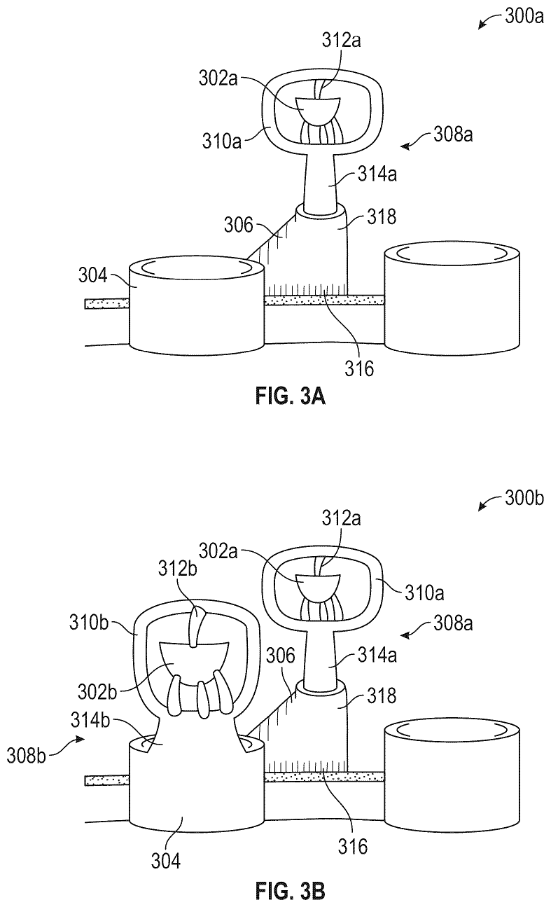

To address these and other challenges, the present technology provides dental auxiliary positioners that may be used for positioning auxiliaries on teeth that are inaccessible (e.g., difficult to reach) using conventional devices. Representative examples of such dental auxiliary positioners are described below in connection with FIGS. 3A-10D and 17A-18E. Any of the features of the embodiments of FIGS. 3A-10D and 17A-18E can be combined with each other and/or with the features of the embodiments of FIGS. 1A and 1B.

In some embodiments, a dental auxiliary positioner is configured to place an auxiliary on a lingual surface of a tooth. Lingual placement of an auxiliary may be desirable if the buccal surface of the tooth is blocked, for aesthetic reasons (e.g., lingual auxiliaries are generally less visible than buccal auxiliaries), if the treatment plan involves applying a force to the lingual surface of the tooth, and/or other relevant considerations. However, lingual placement of an auxiliary may be more challenging than buccal placement of an auxiliary, e.g., due to limited visibility and access of the practitioner, high curvature and/or limited surface area of certain tooth surfaces (e.g., lingual fossa of the incisors), and greater difficulty around salivary isolation (e.g., especially for the lower arch where the tongue and salivary glands may interfere with auxiliary bonding). An auxiliary bonded to the lingual surface can also be blocked, if the tooth surface is obstructed (e.g., by two neighbor teeth behind the tooth requiring the lingual auxiliary).

FIG. 3A is a partially schematic perspective view of a portion of a dental auxiliary positioner 300a for placing a dental auxiliary 302a (e.g., an attachment for an aligner, palatal expander, retainer, mouthguard, etc.) on a lingual surface of an inaccessible tooth, in accordance with embodiments of the present technology. The positioner 300a includes a registration element 304 configured to receive and couple to at least a portion of the tooth, a connector 306 coupled to the registration element 304 and extending toward the lingual surface of the tooth, and an auxiliary support 308a coupled to the connector 306 to position the auxiliary 302a against the lingual surface of the tooth. The registration element 304 and auxiliary support 308a can be identical or generally similar to the corresponding components described above in connection with FIGS. 1A and 1B. For example, the registration element 304 can include a cavity defining an inner surface that engages at least a portion of the occlusal, buccal, and/or lingual surfaces of the tooth to mount the registration element 304 onto the tooth. The auxiliary support 308a can include a frame 310a extending partially or entirely around the perimeter of the auxiliary 302a, one or more struts 312a coupling the auxiliary 302a to the frame 310a, and a bridge 314a coupling the frame 310a to the connector 306. Optionally, one or more of the frame 310a, struts 312a, and/or bridge 314a can be omitted, e.g., to reduce the spatial footprint of the auxiliary support 308a.

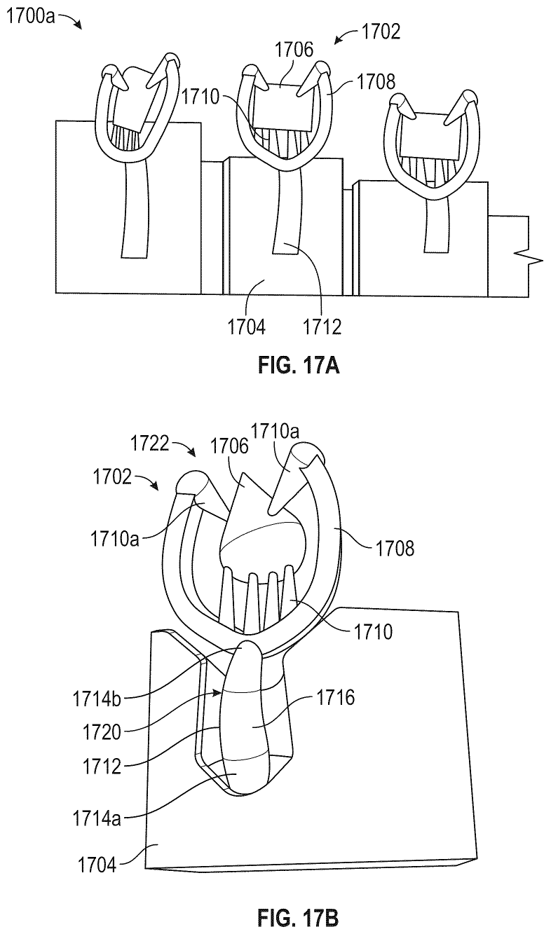

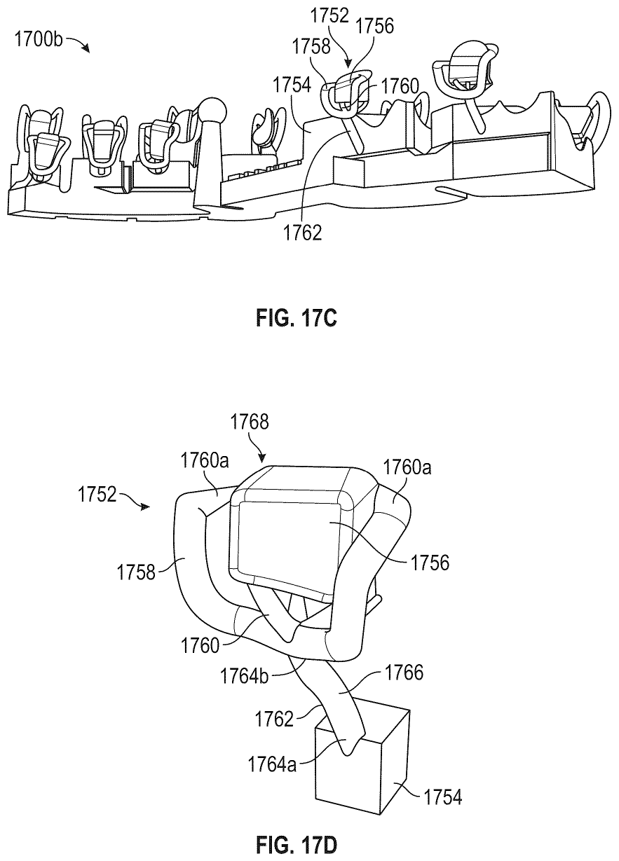

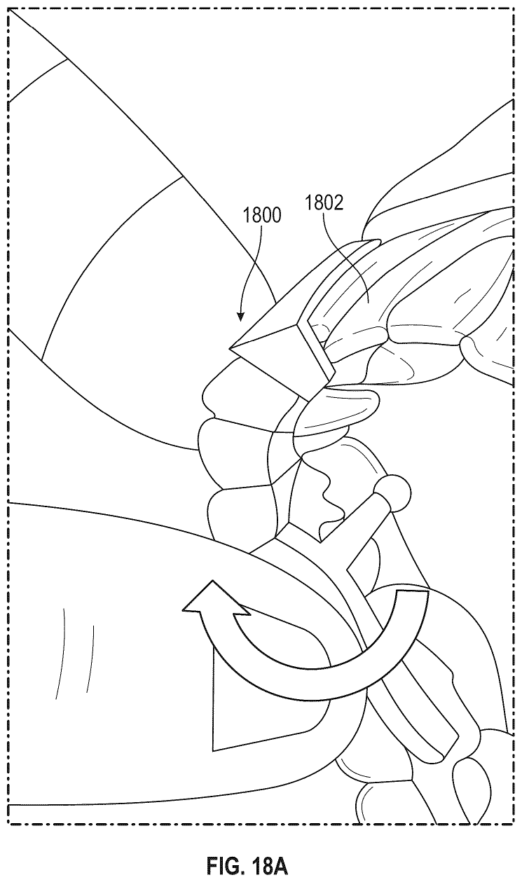

As shown in FIG. 3A, the auxiliary support 308a can be coupled to the registration element 304 via the connector 306, such that when the registration element 304 is engaged with the tooth, the auxiliary support 308a is positioned proximate to the lingual surface of the tooth and the auxiliary 302a is placed against the lingual surface of the tooth at a predetermined location. The connector 306 can be an elongate member (e.g., an arm, shaft, belt, projection, post) including a first end portion 316 connected to the registration element 304 (and/or to another portion of the positioner 300a proximate to the registration element 304), and a second end portion 318 connected to the auxiliary support 308a (e.g., to the bridge 314a of the auxiliary support 308a). The connector 306 can extend away from the registration element 304 in a lingual direction, such that the second end portion 318 is positioned lingual to the first end portion 316. In some embodiments, the connector 306 is flexible to permit some movement of the auxiliary support 308a relative to the registration element 304 (e.g., the connector 306 may be a flexible bridge as discussed further below with respect to FIGS. 17A-17D), while in other embodiments, the connector 306 can be rigid to maintain the auxiliary support 308a in a fixed spatial relationship with respect to the registration element 304.

The auxiliary support 308a can extend away from the second end portion 318 of the connector 306 in a gingival direction (in FIG. 3A, the upward direction) to position the auxiliary 302a at a desired location against the lingual surface of the tooth. Optionally, depending on the inclination of the lingual surface of the tooth, the auxiliary support 308a can be angled buccally or lingually (depending on an angle of a plane of the lingual surface of the tooth) to ensure sufficient contact between the auxiliary 302a and the lingual surface of the tooth.

In the embodiment of FIG. 3A, the buccal side of the registration element 304 does not include any auxiliary supports, such that the only auxiliary placed on the tooth is the lingual auxiliary 302a. This configuration may be used, for example, if it is not possible or desirable to place a buccal auxiliary on the tooth (e.g., due to obstructions and/or for aesthetic reasons) or if a buccal auxiliary is not needed to apply the desired forces to the tooth.

FIG. 3B is a partially schematic perspective view of a portion of a dental auxiliary positioner 300b for placing a first auxiliary 302a on a lingual surface of a tooth and a second auxiliary 302b on a buccal surface of the tooth, in accordance with embodiments of the present technology. The positioner 300b can be generally similar to the positioner 300a of FIG. 3A, except that the positioner 300b also includes a second auxiliary support 308b that is coupled to a buccal side of the registration element 304 to position the second auxiliary 302b on the buccal surface of the received tooth. The second auxiliary support 308b can be identical or generally similar to the corresponding component described above in connection with FIGS. 1A and 1B. For example, the second auxiliary support 308b can include a frame 310b extending partially or entirely around the perimeter of the second auxiliary 302b, one or more struts 312b coupling the second auxiliary 302b to the frame 310b, and a bridge 314b coupling the frame 310b to the registration element 304. Optionally, one or more of the frame 310b, struts 312b, and/or bridge 314b can be omitted, e.g., to reduce the spatial footprint of the second auxiliary support 308b. The positioner 300b can be used in situations where it is desirable to have auxiliaries on both the buccal and lingual surfaces of the tooth, e.g., if forces are to be applied to the tooth from the buccal and lingual surfaces concurrently.

In some embodiments, when either buccal, lingual, and/or occlusal auxiliaries are needed for one or more teeth in a subset of teeth, a separate auxiliary positioner having lingual, buccal, and/or occlusal auxiliaries may be created for the subset. In one example, a dental auxiliary positioner may be created for a segment of a patient's jaw (e.g., right and left quadrants for each of the upper and lower jaws; six sextant segments, three for each of the upper and lower jaws; etc.). In just one example, each of the four quadrants may have an associated lingual auxiliary positioner and a buccal auxiliary positioner (for a total of eight or more auxiliary positioners). In some embodiments, to bond the auxiliaries of a subset (e.g., a quadrant or sextant), a practitioner may first place a buccal (or buccal and lingual) auxiliary positioner corresponding to that subset and bond the buccal (and/or lingual) auxiliaries, and then place a lingual auxiliary positioner corresponding to that subset and bond the lingual auxiliaries. In other embodiments, the lingual auxiliary positioner may be applied before the buccal auxiliary positioner. In some cases at least, having this system of multiple separate positioners enables independent bonding of the buccal and lingual auxiliaries, such that a dental practitioner can better control the isolation for the teeth surfaces to which an auxiliary is to be bonded from saliva, and manage patient comfort since the procedure can require placing multiple appliances in the oral cavity at once (e.g., saliva ejectors, cheek retractors, etc.) to maintain a dry field. For example, the dental practitioner can isolate the lingual surfaces of a subset of teeth (e.g., a quadrant) to bond the lingual auxiliaries, and then subsequently isolate the buccal/occlusal surfaces and bond buccal/occlusal auxiliaries, and vice-versa. It may be more challenging in these cases to simultaneously isolate saliva from both buccal and lingual surfaces.

Although the embodiments of FIGS. 3A and 3B depict a single lingual auxiliary, a dental auxiliary positioner of the present technology can be configured to position any suitable number of lingual auxiliaries on a patient's teeth, such as two, three, four, five, or more lingual auxiliaries. Each lingual auxiliary can be coupled to a respective registration element via a respective connector and auxiliary support. Some or all of the lingual auxiliaries may be the only auxiliary on the respective tooth, or some or all of the lingual auxiliaries may be used in combination with another auxiliary (e.g., a buccal auxiliary) on the same tooth.

In some embodiments, a dental auxiliary positioner is configured to place a dental auxiliary on a tooth without a registration element that receives and engages that tooth. Instead, the auxiliary can be coupled to a connector between one or more registration elements that mount to one or more neighboring teeth. This approach can be used, for example, if it is difficult or impossible to place a registration element on the tooth, such as if the tooth is blocked or crowded by the neighboring teeth and/or by other objects. This approach can also be used if a registration element placed on the tooth would obstruct an energy applicator (e.g., a curing wand) from accessing the auxiliary to bond the auxiliary to the tooth. This approach can also be used in situations where it is desirable to place an auxiliary on a tooth surface that would otherwise be covered by the registration element, such as an occlusal auxiliary for use as an occlusal block for disoccluding posterior and/or anterior teeth. Alternatively or in addition, this approach can be used to reduce the number of registration elements present in the positioner, which may increase the flexibility of the positioner. A more flexible positioner can be beneficial for improving the tolerance of the positioner to fit errors (e.g., discrepancies between the geometry of the positioner and the actual geometry of the patient's teeth). For example, fit errors may be caused by inaccurate or incomplete intraoral scan data used to design the positioner, and/or by changes in tooth position after the intraoral scan data is taken.

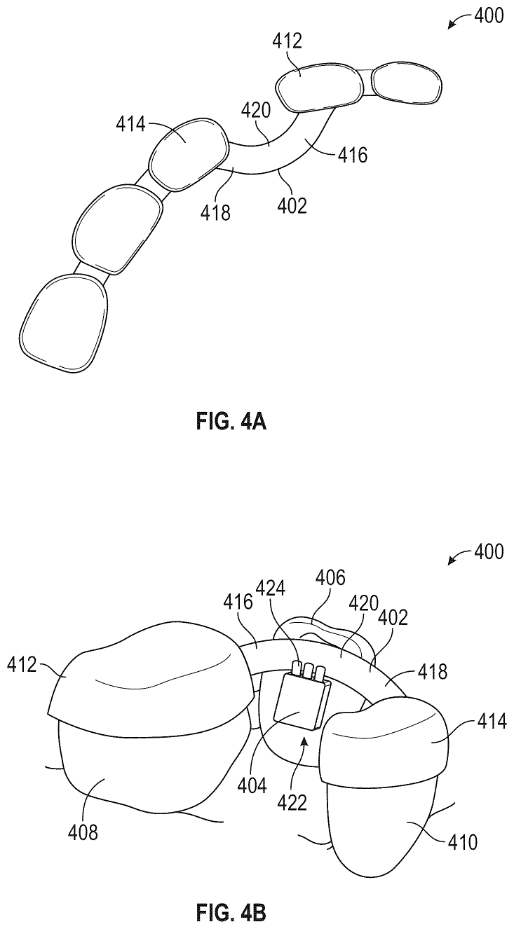

FIGS. 4A and 4B are partially schematic illustrations of a dental auxiliary positioner 400 with a connector 402 for positioning an auxiliary 404 on a target tooth 406, in accordance with embodiments of the present technology. Specifically, FIG. 4A is a top view of the positioner 400 and FIG. 4B is a perspective view of a portion of the positioner 400 on a patient's teeth.

Referring first to FIG. 4B, the positioner 400 can be used to place an auxiliary 404 on a target tooth 406 that is positioned between one or more other teeth, such as a first tooth 408 and/or a second tooth 410. In the illustrated embodiment, the first tooth 408 and second tooth 410 are immediately adjacent to the target tooth 406. In other embodiments, however, there may be one or more additional teeth between the target tooth 406 and the first tooth 408, and/or between the target tooth 406 and the second tooth 410. Moreover, although FIG. 4B shows the first tooth 408 and second tooth 410 blocking the target tooth 406 (e.g., a buccal or lingual surface of the target tooth 406 is partially covered by the first tooth 408 and/or the second tooth 410), the positioner 400 can also be used in situations where the target tooth 406 is not blocked by other teeth.

Referring next to FIGS. 4A and 4B together, the positioner 400 includes one or more registration elements that are flexibly or rigidly coupled to each other to form a unitary appliance body. The registration elements can include a first registration element 412 that couples to the first tooth 408, and a second registration element 414 that couples to the second tooth 410. The first registration element 412 and second registration element 414 can be identical or generally similar to the corresponding components described above in connection with FIGS. 1A and 1B. For example, the first registration element 412 and the second registration element 414 can each include a cavity defining an inner surface that engages at least a portion of the occlusal, buccal, and/or lingual surfaces of the first tooth 408 and the second tooth 410, respectively.

As shown in FIGS. 4A and 4B, the positioner 400 does not include a registration element between the first registration element 412 and second registration element 414 to couple to the target tooth 406. Instead, the positioner 400 includes a connector 402 coupled to and extending between the first registration element 412 and the second registration element 414. In some embodiments, the connector 402 is differentiated from the registration elements in that the connector 402 does not contact the target tooth 406, e.g., the connector 402 is spaced apart from the occlusal, lingual, and/or buccal surfaces of the target tooth 406. In other embodiments, the connector 402 may contact the target tooth 406 (e.g., to improve stability), but the amount of contact between the connector 402 and the target tooth 406 may be less than the amount of contact between the registration elements and their corresponding received teeth (e.g., the connector 402 contacts a buccal or lingual surface but not the occlusal surface of the target tooth 406).

The connector 402 can carry an auxiliary support 422 that positions the auxiliary 404 at a predetermined location on the target tooth 406 (the auxiliary support 422 is omitted in FIG. 4A merely for purposes of simplicity). In some embodiments, the connector 402 is flexible to permit some movement of the auxiliary support 422 relative to the first registration element 412 and the second registration element 414, while in other embodiments, the connector 402 can be rigid to maintain the auxiliary support 422 in a fixed spatial relationship with respect to the first registration element 412 and the second registration element 414.

In some embodiments, the connector 402 is an elongate member (e.g., an arm, shaft, belt, bar, rod) having a first end portion 416 connected to the first registration element 412, a second end portion 418 connected to the second registration element 414, and an intermediate portion 420 between the first end portion 416 and the second end portion 418. The intermediate portion 420 can be coupled to an auxiliary support 422 carrying the auxiliary 404. As best seen in FIG. 4B, the intermediate portion 420 of the connector 402 can be positioned proximate to a surface (e.g., a buccal, lingual, or occlusal surface) of the target tooth 406 such that the auxiliary support 422 places the auxiliary 404 against the surface of the target tooth 406 for bonding. In the illustrated embodiment, the intermediate portion 420 of the connector 402 has a curved shape to fit between the first tooth 408 and the second tooth 410, and to position the auxiliary support 422 proximate to the surface of the target tooth 406. In other embodiments, however, the intermediate portion 420 can have a different shape (e.g., a straight shape, an angled shape), depending on the position of the target tooth 406 relative to the first tooth 408 and the second tooth 410, and/or the placement location of the auxiliary 404 on the target tooth 406.

The auxiliary support 422 can include one or more struts 424 coupling the auxiliary 404 to the connector 402. The struts 424 can be fractured to release the auxiliary 404 from the positioner 400 after bonding, as described elsewhere herein. In the illustrated embodiment, the auxiliary support 422 does not include a frame or a bridge, which can be advantageous to reduce the size of the auxiliary support 422 to fit into smaller spaces (e.g., if the surface of the target tooth 406 is partially obstructed by the first tooth 408 and/or the second tooth 410). Alternatively, the auxiliary support 422 can include a frame and/or a bridge if there is sufficient space to accommodate these components. In such embodiments, the frame and bridge can be configured similarly to the corresponding components described in connection with FIGS. 1A and 1B.

The auxiliary support 422 can be manufactured together with the connector 402, such that the auxiliary support 422 is integrally formed with the connector 402. In some embodiments, the entire positioner 400, including the auxiliary 404, auxiliary support 422, connector 402, first registration element 412, and second registration element 414, is fabricated in a single manufacturing operation (e.g., via a single additive manufacturing process). Alternatively, some portions of the positioner 400 can be discrete components that are fabricated separately (e.g., via separate additive manufacturing processes) and subsequently assembled to form the positioner 400, e.g., the auxiliary support 422 can be fabricated in a separate operation and subsequently coupled to the connector 402.

Although FIGS. 4A and 4B depict a connector 402 that is connected at both ends to first and second registration elements 412, 414, the dental auxiliary positioners described herein can alternatively or additionally include a connector for an auxiliary support that is connected to a single registration element only. For instance, referring again to FIGS. 3A and 3B, the registration element 304 can receive a first tooth, and the connector 306 can be used to place the auxiliary support 308a and auxiliary 302a on a buccal or lingual surface of a second tooth that is rendered inaccessible by the first tooth.

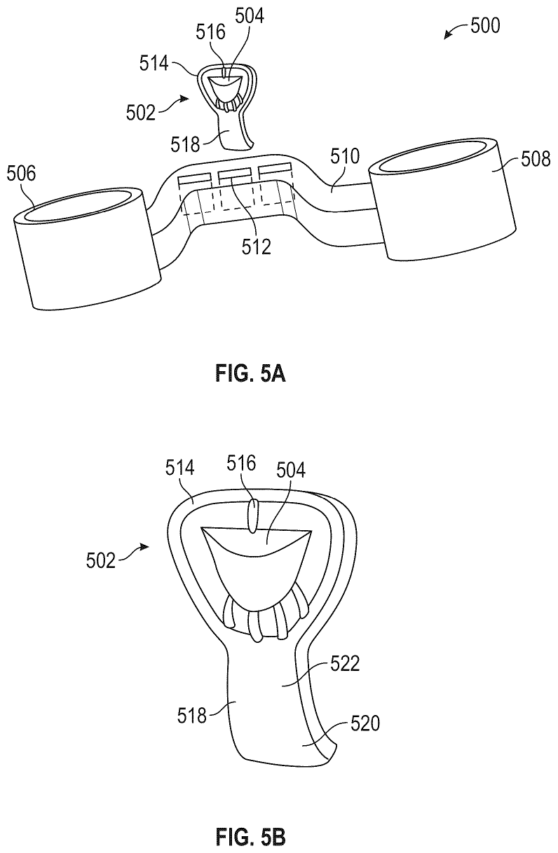

FIGS. 5A and 5B are partially schematic illustrations of a dental auxiliary positioner 500 with a discrete auxiliary support 502 for placing an auxiliary 504 on a tooth, in accordance with embodiments of the present technology. Specifically, FIG. 5A is a perspective view of a portion of the positioner 500 having a plurality of openings 512 for receiving an auxiliary support (e.g., the auxiliary support 502), and FIG. 5B is a perspective view of the auxiliary support 502. The positioner 500 includes a first registration element 506 that couples to a first tooth, a second registration element 508 that couples to a second tooth, and a connector 510 between the first registration element 506 and the second registration element 508 that extends toward a target tooth between the first tooth and the second tooth. The features of the first registration element 506, second registration element 508, and connector 510 can be generally similar to the corresponding components of FIGS. 4A and 4B.

The auxiliary support 502 is configured to couple to the connector 510 such that when the positioner 500 is worn on the patient's teeth, the auxiliary support 502 places the auxiliary 504 at a predetermined location on the target tooth. As best seen in FIG. 5B, the auxiliary support 502 can include a frame 514 extending partially or entirely around the perimeter of the auxiliary 504, one or more struts 516 coupling the auxiliary 504 to the frame 514, and a bridge 518 coupling the frame 514 to the connector 510. The bridge 518 can be an elongate member including a first end portion 520 configured to couple to the connector 510, and a second end portion 522 connected to the frame 514. Optionally, the frame 514 can be omitted, such that the second end portion 522 is connected directly to the struts 516.

In the illustrated embodiment, the connector 510 includes a plurality of openings 512 (e.g., slots, holes, apertures, indentations) configured to receive and couple to the auxiliary support 502. The first end portion 520 of the bridge 518 of the auxiliary support 502 can be configured to fit into any one of the openings 512 in the connector 510, thereby coupling the auxiliary support 502 to the connector 510. The coupling between the bridge 518 of the auxiliary support 502 and an individual opening 512 of the connector 510 can be accomplished via any suitable technique, such as mechanical fixation (e.g., interference fit, snap fit, interlocking features), adhesives (e.g., curable adhesives, contact adhesives, pressure-sensitive adhesives), fasteners (e.g., pins, staples, screws, ties), or combinations thereof.

The connector 510 can include any suitable number of openings 512, such as two, three, four, five, or more openings 512. The openings 512 can be distributed along the length of the connector 510, thus allowing the auxiliary support 502 to be coupled to different positions on the connector 510. Accordingly, a user (e.g., a clinician) can select which opening 512 the auxiliary support 502 should be inserted into to place the auxiliary 504 at the appropriate location on the patient's teeth. This can be advantageous, for example, to allow the positioning of the auxiliary support 502 to be adjusted to accommodate fit errors. Although the illustrated openings 512 are positioned across a horizontal of the connector 510, the connector may include openings at different vertical positions on the connector or any other suitable orientation (e.g., angled to the left or right) or position (e.g., diagonally positioned).

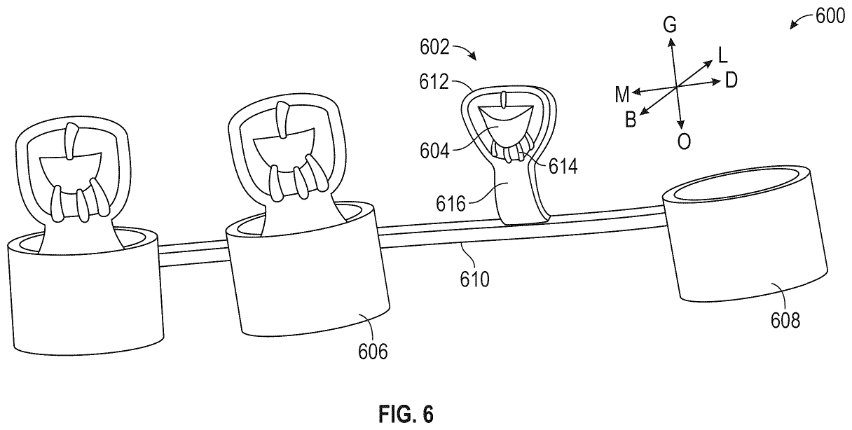

FIG. 6 is a partially schematic perspective view of a portion of a dental auxiliary positioner 600 with an adjustable auxiliary support 602 for placing an auxiliary 604 on a tooth, in accordance with embodiments of the present technology. The positioner 600 includes a first registration element 606 that couples to a first tooth, a second registration element 608 that couples to a second tooth, and a connector 610 between the first registration element 606 and the second registration element 608 that extends toward a target tooth between the first tooth and the second tooth. The features of the first registration element 606, second registration element 608, and connector 610 can be generally similar to the corresponding components of FIGS. 4A-5B.

The auxiliary support 602 is configured to couple to the connector 610 such that when the positioner 600 is worn on the patient's teeth, the auxiliary support 602 places the auxiliary 604 at a predetermined location on the target tooth. In some embodiments, the auxiliary support 602 is integrally formed with the connector 610, while in other embodiments, the auxiliary support 602 can be a discrete component that is fabricated separately from and subsequently coupled to the connector 610 as described herein. As shown in FIG. 6, the auxiliary support 602 can include a frame 612 extending partially or entirely around the perimeter of the auxiliary 604, one or more struts 614 coupling the auxiliary 604 to the frame 612, and a bridge 616 coupling the frame 612 to the connector 610. Optionally, the frame 612 can be omitted, such that the bridge 616 is connected directly to the struts 614.

In some embodiments, the auxiliary support 602 is adjustable in one or more directions to allow the positioning of the auxiliary 604 to be adjusted relative to the rest of the positioner 600 and to the patient's teeth (e.g., to accommodate fit errors). For example, the auxiliary support 602 can be adjustable along an occlusal-gingival direction (OG), a mesial-distal direction (MD), and/or a buccal-lingual direction (BL). The adjustability of the auxiliary support 602 can be achieved using various techniques. For instance, the bridge 616 of the auxiliary support 602 can be a flexible structure that can deflect (e.g., move and/or bend) in one or more directions, thus allowing the auxiliary 604 to be moved into different positions and/or orientations relative to the positioner 400 (e.g., as discussed further below with respect to FIGS. 17A-17D). In some embodiments, the bridge 616 is made partially or entirely out of a flexible material, such as a metal or polymer. Alternatively or in combination, the bridge 616 can have a structure that allows for flexibility in different directions, such as one or more springs (e.g., leaf spring, coiled spring, accordion spring), movable linkages (e.g., hinged joints, ball joints), slidable elements, bendable elements, etc., or a combination thereof.

In some embodiments, for example, the bridge 616 is or includes a compliant mechanism (e.g., a compliant spring). The compliant mechanism can include one or more flexible elements (e.g., flexible beams) that are deformable to allow for relative motion between the parts of the compliant mechanism. The compliant mechanism can be configured so that a set amount of input force produces a set amount of movement, thereby allowing for controlled adjustments of the auxiliary 604 within a constrained range of motion. This approach can be advantageous to ensure that the auxiliary 604 is not placed at an unacceptable location on the target tooth, while still allowing some flexibility to accommodate fit errors.

A dental auxiliary positioner of the present technology can include any suitable number of auxiliaries that are positioned on a tooth using a connector between registration elements on a patient's teeth, such as two, three, four, five, or more auxiliaries. Moreover, although the embodiments of FIGS. 4A-6 illustrate a single auxiliary support coupled to a connector to place an auxiliary on a single tooth, in other embodiments, a connector can be coupled to a plurality of auxiliary supports (e.g., two, three, four, five, or more auxiliary supports) to a place a plurality of auxiliaries on a plurality of respective teeth. Stated differently, a pair of registration elements can be used to anchor a positioner to a pair of teeth, and a connector between the registration elements can be used to carry multiple auxiliary supports for placing auxiliaries on multiple teeth between the pair of teeth. In some embodiments, a dental auxiliary positioner may include an auxiliary support (or multiple auxiliary supports) that is configured to place two or more auxiliaries on a single tooth (e.g., a button for engaging an elastic and an attachment for engaging an attachment cavity of an aligner). Additionally, although the embodiments of FIGS. 4A-6 illustrates auxiliary supports on a connector that is coupled to two registration elements, in other embodiments, a connector can be coupled to a single registration element (e.g., one end portion of the connector is coupled to the registration element, while the other end portion is a “free-floating” unconnected end).

In some embodiments, a dental auxiliary positioner may be configured to be positioned over all teeth of a patient's upper or lower jaw, and may include auxiliaries for some or all of those teeth. In some embodiments, a dental auxiliary positioner may be configured to be positioned over a subset of the teeth of a patient's upper or lower jaw. For example, a patient's teeth may be conceptualized as being divided into four quadrants (two in the upper jaw and two in the lower jaw), and a single dental auxiliary positioner may be configured to fit over a particular quadrant of the patient's upper or lower jaw. In this example, dental auxiliary positioners may be created for each quadrant that is in need of an auxiliary, and the dental auxiliary positioners may be applied to their respective quadrants for bonding the auxiliaries to their respective teeth.

In some embodiments, a dental auxiliary positioner includes at least one auxiliary support with a geometry that has been modified to accommodate at least one object proximate to a tooth (e.g., an object that blocks the tooth). The object can be another tooth (e.g., an adjacent tooth), another portion of the positioner (e.g., another auxiliary, another auxiliary support, a registration element), and/or another device present in the intraoral cavity (e.g., another dental appliance, another auxiliary that is currently mounted on or is intended to be mounted on the same tooth or another tooth). The modification to the auxiliary support can include changing an initial and/or default design of the auxiliary support by removing a portion of the auxiliary support that would otherwise collide or come too close to the object, by changing a shape of a portion of the auxiliary support that would otherwise collide or come too close to the object, or a combination thereof. For example, modifications can be made to the frame, struts, and/or bridge of an auxiliary support. The modification can be made such that a minimum separation distance between the modified auxiliary support and the object is greater than a threshold value, e.g., at least 0.01 mm, 0.02 mm, 0.05 mm, 0.08 mm, 0.1 mm, or 0.5 mm. Such modifications can allow dental auxiliary positioners to be used to accurately place auxiliaries on teeth that are severely maloccluded and/or crowded. The modifications can also be made to avoid positioner designs that are not manufacturable and/or usable.

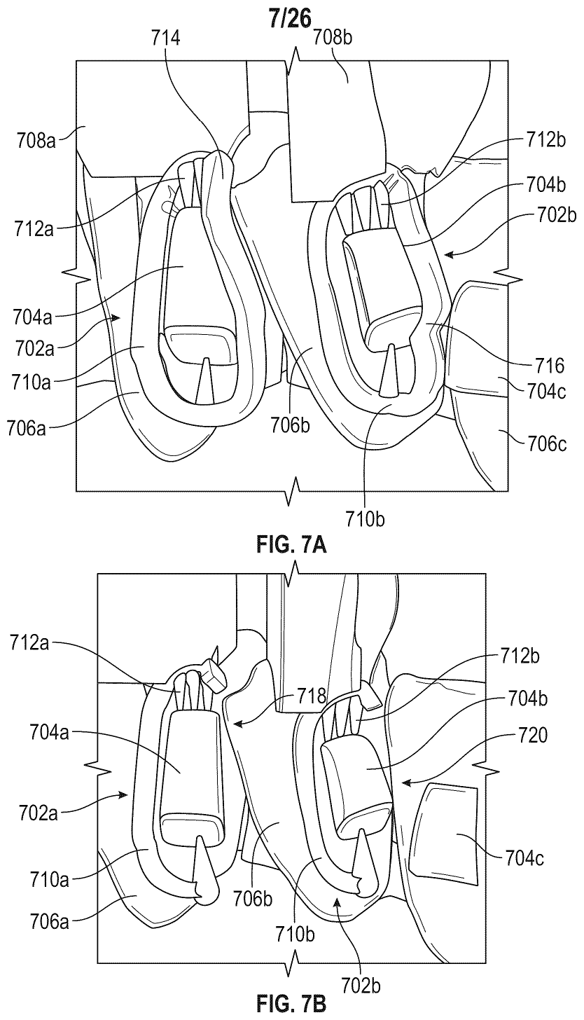

FIGS. 7A and 7B illustrate modifications that may be made to auxiliary supports to accommodate other objects, in accordance with embodiments of the present technology. Specifically, FIG. 7A illustrates initial designs for a first auxiliary support 702a and a second auxiliary support 702b that are too close to other objects, and FIG. 7B illustrates modified designs for the first auxiliary support 702a and the second auxiliary support 702b to accommodate the other objects.

Referring first to FIG. 7A, the first auxiliary support 702a is configured to place a first auxiliary 704a on a first tooth 706a, and is coupled to a first registration element 708a that receives the first tooth 706a. The first auxiliary support 702a includes a first frame 710a that extends around the entire perimeter of the first auxiliary 704a and is connected to the first auxiliary 704a via one or more first struts 712a. Similarly, the second auxiliary support 702b is configured to place a second auxiliary 704b on a second tooth 706b proximate to the first tooth 706a, and is coupled to a second registration element 708b that receives the second tooth 706b. The second auxiliary support 702b includes a second frame 710b that extends around the entire perimeter of the second auxiliary 704b and is connected to the second auxiliary 704b via one or more second struts 712b.

As shown in FIG. 7A, a portion 714 of the first frame 710a is too close to the second tooth 706b, e.g., the second tooth 410 may collide or otherwise interfere with the portion 714 of the first frame 710a. A portion 716 of the second frame 710b is too close to a third tooth 706c proximate to the second tooth 706b and/or a third auxiliary 704c on the third tooth 706c, e.g., the third tooth 706c and/or the third auxiliary 704c may collide or otherwise interfere with the portion 716 of the second frame 710b. Accordingly, it may be difficult or impossible to manufacture a positioner having the designs for the first auxiliary support 702a and second auxiliary support 702b shown in FIG. 7A, and/or such a positioner may not be capable of placing the first auxiliary 704a and second auxiliary 704b at the respective desired locations on the first tooth 706a and second tooth 706b.

Referring next to FIG. 7B, the designs of the first auxiliary support 702a and the second auxiliary support 702b can be modified to avoid collisions or interference with other objects. For example, the portion 714 of the first frame 710a that comes too close to the second tooth 706b can be partially or entirely removed (e.g., trimmed, truncated), thereby leaving a gap 718 in the first frame 710a to accommodate the second tooth 706b. Similarly, the portion 716 of the second frame 710b that comes too close to the third tooth 706c and/or the third auxiliary 704c can be partially or entirely removed, thereby leaving a gap 720 in the second frame 710b to accommodate the third tooth 706c and/or the third auxiliary 704c. Any of the struts 712a, 712b that were connected to the removed portions 714, 716 of the first frame 710a and second frame 710b, respectively, can also be removed. The gaps 718, 720 can be sufficiently large so there is sufficient separation between the remaining portions of the first and second frames 710a, 710b and other objects, but also sufficiently small so that the first and second auxiliaries 704a, 704b can still be precisely placed at the desired locations. In some instances, the portions 714, 716 that are removed constitute no more than 75%, 70%, 66%, 60%, 50%, 40%, 33%, 30%, or 25% of the total initial length of the respective frames 710a, 710b. Alternatively or in combination, the remaining portions of the frames 710a, 710b can extend around at least 25%, 30%, 33%, 40%, 50%, 60%, 66%, 70%, or 75% of the perimeter of the respective auxiliaries 704a, 704b. Moreover, the portions of the frames 710a, 710b that are proximate to the respective registration elements 708a, 708b can be maintained, e.g., to avoid destabilizing the connection between the auxiliary supports 702a, 702b and the respective registration elements 708a, 708b, as well as to protect the respective auxiliaries 704a, 704b from damage. In some embodiments, a frame may be modified to avoid collisions or interference by changing the shape of the frame (alternative to or in addition to removing portions of the frame). For example, a portion of a frame that would otherwise interfere with an object (e.g., a tooth, another auxiliary, a portion of the positioner) may be bent or otherwise shaped such that it does not interfere with the object.

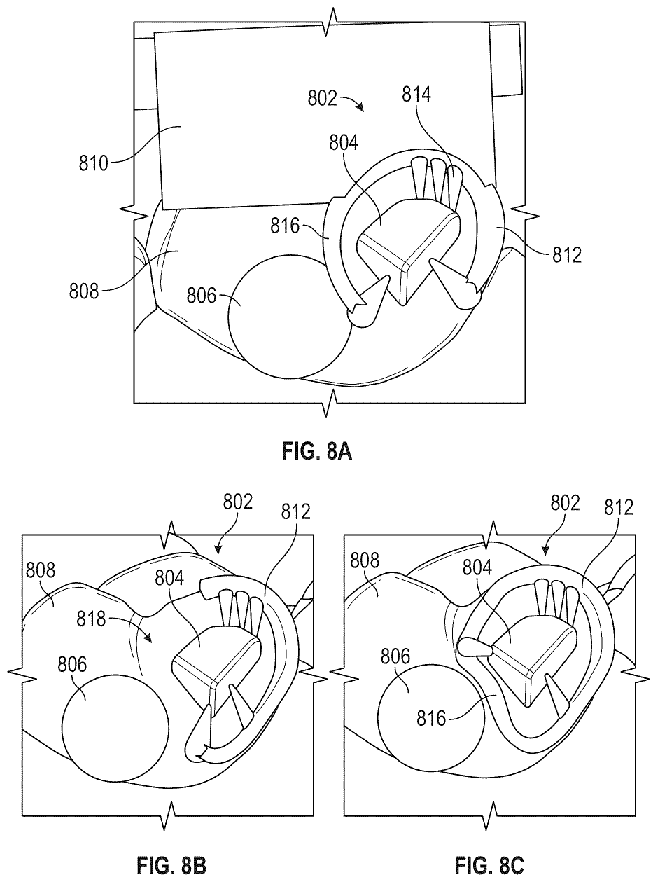

FIGS. 8A-8C illustrate modifications to the design of an auxiliary support 802 for a first auxiliary 804 to accommodate a second auxiliary 806 mounted on a tooth 808 (e.g., in the case where both first and second auxiliaries are to be bonded to the same tooth), in accordance with embodiments of the present technology. Specifically, FIG. 8A illustrates an initial design for the auxiliary support 802 that is too close to the second auxiliary 806, and FIGS. 8B and 8C illustrate a modified design for the auxiliary support 802 to accommodate the second auxiliary 806.

Referring first to FIG. 8A, the auxiliary support 802 is configured to place a first auxiliary 804 on the tooth 808, and is coupled to a registration element 810 that receives the tooth 808 (the registration element 810 is omitted in FIGS. 8B and 8C merely for purposes of simplicity). The auxiliary support 802 includes a frame 812 that extends at least partially around the perimeter of the first auxiliary 804 and is connected to the first auxiliary 804 via one or more struts 814. As shown in FIG. 8A, a portion 816 of the frame 812 is too close to a second auxiliary 806 that is already mounted on or is intended to be mounted on the same tooth 808, e.g., the second auxiliary 806 may collide or otherwise interfere with the portion 816 of the frame 812. In some embodiments, the first auxiliary 804 is an attachment that is configured to engage a dental appliance, and the second auxiliary 806 is a dental feature (e.g., a button, hook, etc.) that is configured to receive an elastic. In some embodiments, a first positioner is applied to bond the first auxiliary, the first positioner is then removed, and a second positioner is applied to bond the second auxiliary. In other embodiments, the second positioner is applied to bond the second auxiliary, the second positioner is then removed, and the first positioner is applied to bond the second auxiliary.

Referring next to FIG. 8B, the design of the auxiliary support 802 can be modified to avoid collisions or interference with other objects. For example, the portion 816 of the frame 812 that comes too close to the second auxiliary 806 can be partially or entirely removed (e.g., trimmed, truncated), thereby leaving a gap 818 to accommodate the second auxiliary 806. As another example, the location and geometry of the second auxiliary 806 can be detected and used to design the frame 812 with the gap 818 to accommodate the second auxiliary 806. The size and location of the gap 818 can be selected to provide a sufficiently large separation distance between the remaining portions of the frame 812 and the second auxiliary 806, while also maintaining stability and accurate placement of the first auxiliary 804 at the desired location on the tooth 808, as described elsewhere herein.

Referring next to FIG. 8C, the design of the auxiliary support 802 can alternatively or additionally be modified by altering a shape of the portion 816 of the frame 812. In the illustrated embodiment, for example, the shape of the portion 816 has been adjusted to curve away from the second auxiliary 806, thereby maintaining a minimum separation distance between the frame 812 and the second auxiliary 806. Optionally, the modified shape of the portion 816 of the frame 812 can be used to guide placement of the second auxiliary 806 on the tooth 808, such as in embodiments where the second auxiliary 806 is mounted on the tooth 808 concurrently with or after a positioner including the auxiliary support 802. For example, the modified shape of the portion 816 of the frame 812 can be similar and/or complementary to the shape of a corresponding portion of the second auxiliary 806, e.g., the portion 816 can have the same or a similar curvature as the corresponding portion of the second auxiliary 806. Accordingly, a practitioner (e.g., a clinician) can use the frame 812 as a visual guide to position the second auxiliary 806 at the appropriate location on the tooth 808. In this example, the second auxiliary 806 may be positioned and applied without a separate positioner by the practitioner, with a separate positioner that is placed on top of the current positioner, or with a separate auxiliary that is coupled to the current positioner. This approach can simplify the treatment procedure by allowing the first auxiliary 804 and second auxiliary 806 to be placed on the tooth 808 at the same time. By simultaneous positioning and/or bonding of the auxiliaries, redundancies can be eliminated to save considerable time and effort that would otherwise be needed for preparing teeth surfaces (e.g., drying and isolating a surface from saliva, etching the surface to enable bonding), positioning the auxiliaries, and bonding the auxiliaries. For example, a practitioner may be able to do each of these steps once instead of having to do it multiple times for each bonding (e.g., a first time for a first auxiliary, and a second time for a second auxiliary).

In some embodiments, a dental auxiliary positioner includes at least one auxiliary support that is configured to reduce or eliminate debris produced when the auxiliary is released from the auxiliary support. As described elsewhere herein, an auxiliary may be coupled to an auxiliary support via one or more breakable struts that are fractured (e.g., manually or with aid of a tool) to separate the auxiliary from the rest of the positioner, after the auxiliary has been bonded to the tooth. In some instances, the forces that are applied to the auxiliary support to fracture the struts may cause other portions of the auxiliary support to fracture. For example, the frame may be particularly susceptible to unintended fracturing since this component is typically relatively thin and fragile. Unintended fracturing of the frame and/or other portions of the auxiliary support may produce loose debris that presents safety risks, such as if the debris is swallowed by the patient, if the debris strikes the patient or clinician, etc. Moreover, a positioner that produces debris upon fracturing may be undesirable from a user experience standpoint.

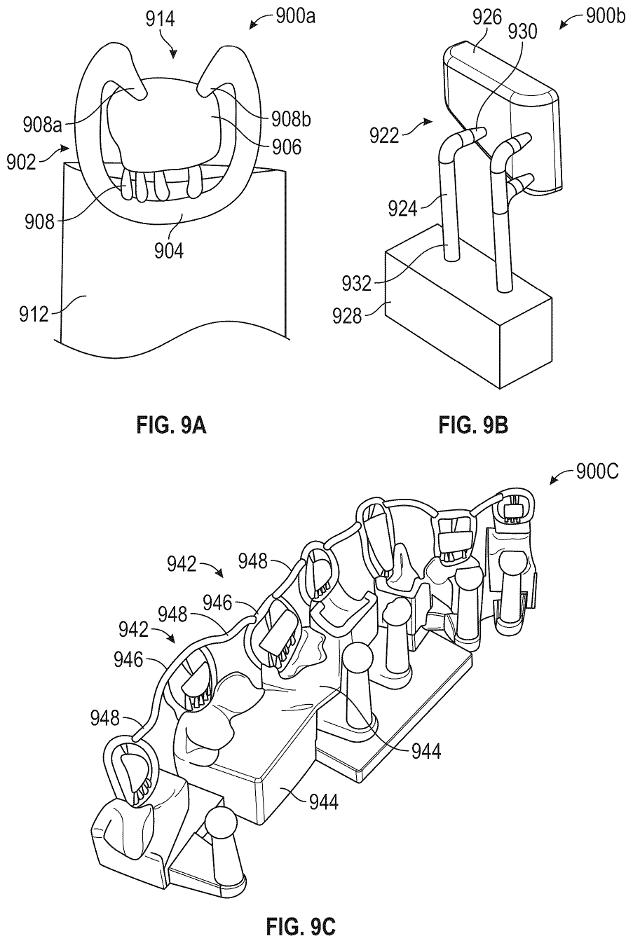

FIG. 9A is a front view of a portion of a dental auxiliary positioner 900a including an auxiliary support 902 configured to reduce debris, in accordance with embodiments of the present technology. The auxiliary support 902 includes a frame 904 extending partially around an auxiliary 906, and a plurality of struts 908 coupling the frame 904 to the auxiliary 906. The auxiliary 906 can be coupled to a registration element 912 that receives the tooth to which the auxiliary 906 is to be mounted.

As shown in FIG. 9A, the frame 904 is trimmed or truncated to include a gap 914, such that the frame 904 has a U-shaped or C-shaped structure. The size of the gap 914 can be varied as desired, e.g., the gap 914 can span at least 10%, 20%, 25%, 30%, 33%, 40%, 50%, 60%, 66%, 70%, or 75% of the perimeter of the auxiliary 906; and/or the gap 914 can span no more than 25%, 30%, 33%, 40%, 50%, 60%, 66%, 70%, 75%, 80%, or 90% of the perimeter of the auxiliary 906. Optionally, the auxiliary support 902 can include at least a first strut 908a and a second strut 908b that are positioned adjacent to the gap 914, e.g., to stabilize the auxiliary 906.

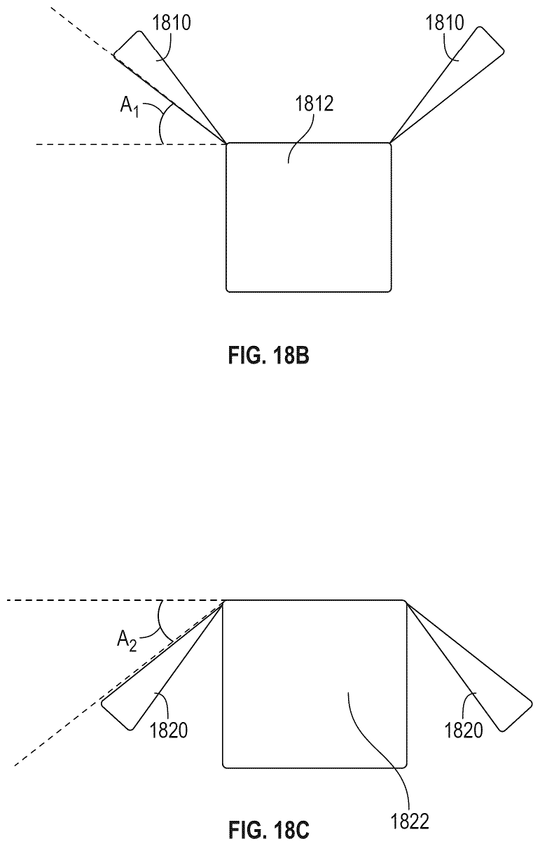

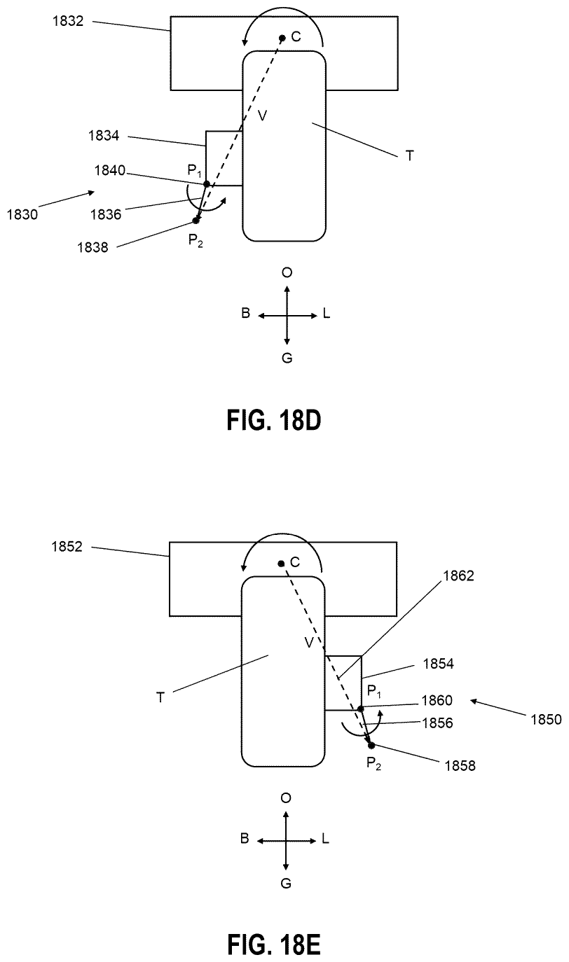

The gap 914 can be positioned at a first side of the frame 904 that is opposite to a second side of the frame 904 that is coupled to the registration element 912. In some embodiments, the first side is a gingival side of the frame 904, and the second side is an occlusal side of the frame 904. Stresses produced by removal of the positioner 900a may be concentrated near the gingival side of the positioner 900a (e.g., at the interface between the first strut 908a and the auxiliary 906, and the interface between the second strut 908b and the auxiliary 906), such that the gingival portion of the frame 904 is more susceptible to fracturing. Accordingly, removal of the gingival portion of the frame 904 can reduce the likelihood of the frame 904 fracturing to produce loose debris. Additional features that may be incorporated into the positioner 900a of FIG. 9A are described below, e.g., with respect to FIGS. 17A-18E.

FIG. 9B is a perspective view of a portion of a dental auxiliary positioner 900b including a frameless auxiliary support 922 to reduce debris, in accordance with embodiments of the present technology. The auxiliary support 922 includes one or more struts 924 that are coupled directly to an auxiliary 926 without any frame, since the frame may be highly susceptible to unintended fracturing as discussed above. As shown in FIG. 9B, each strut 924 can include at least one first end portion 930 connected to the auxiliary 926, and a second end portion 932 connected to the registration element 928. The first end portions 930 of the struts 924 can be curved and/or angled relative to the remaining portions of the struts 924 to position the auxiliary 926 against the tooth surface.

FIG. 9C is a perspective view of a portion of a dental auxiliary positioner 900c including interconnected auxiliary supports 942 to reduce debris, in accordance with embodiments of the present technology. The positioner 900c includes a plurality of auxiliary supports 942 that are coupled to a corresponding plurality of registration elements 944, as described elsewhere herein. As shown in FIG. 9C, the frames 946 of some or all of the auxiliary supports 942 can be coupled to the frames 946 of one or more neighboring auxiliary supports 942 via one or more frame connectors 948. The frame connectors 948 can be any structure suitable for connecting the frames 946 to each other, such as elongate members, wires, ribbons, crossbars, etc., and may be rigid or flexible. Thus, even if one or more of the frames 946 fracture during positioner removal, the frame connectors 948 can keep the fractured frame 946 connected to the rest of the positioner 900c, thereby preventing the formation of loose debris. The frame connectors 948 can be formed integrally with the frames 946, or can be formed separately and then coupled to the frames 946.

In some embodiments, a dental auxiliary positioner of the present technology is configured without registration elements on one or more distalmost teeth of the patient's arch (e.g., the distalmost molar(s)). This approach can allow for more space within the patient's intraoral cavity to isolate teeth that will receive auxiliaries from saliva. For instance, saliva isolation devices such as cotton rolls, gauze, etc., can be placed proximate to the teeth to absorb and/or deflect saliva away from the surfaces of teeth that will receive auxiliaries. It may be advantageous to reduce or minimize saliva on tooth surfaces during the bonding process, since the presence of moisture may interfere with bonding of auxiliaries to the teeth, as discussed elsewhere herein. Thus, by providing additional space in the posterior region of the patient's mouth to accommodate placement of saliva isolation devices, the dental auxiliary positioners disclosed herein can facilitate better adhesion of auxiliaries to the teeth.

Although some embodiments of the dental auxiliary positioner described herein are configured to couple to a plurality of a patient's teeth, in other embodiments, a dental auxiliary positioner of the present technology can be configured to couple to a single tooth. A “single tooth” positioner can be more compact than a “multi-tooth” positioner and can therefore be advantageous, for example, for placing an auxiliary on an inaccessible tooth in at least some cases.

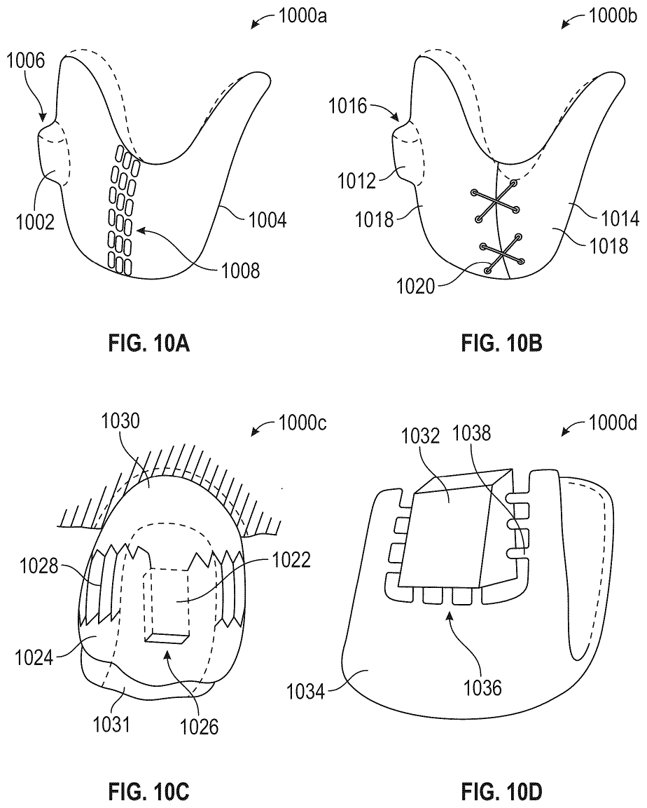

FIGS. 10A-10D illustrate representative examples of dental auxiliary positioners for placing an attachment on a single tooth, in accordance with embodiments of the present technology. Any of the features of the embodiments of FIGS. 10A-10D can be combined with each other. Moreover, the embodiments of FIGS. 10A-10D can be combined with or substitute for any of the other embodiments of dental auxiliary positioners disclosed herein.

FIG. 10A is a perspective view of a dental auxiliary positioner 1000a for placing an auxiliary 1002 on a single tooth, in accordance with embodiments of the present technology. The positioner 1000a includes a cap 1004 that is configured to fit onto the crown of a tooth. In some embodiments, the cap 1004 serves as a registration element, in that the cap 1004 can include a cavity formed therein to define an inner surface that engages a corresponding surface of the received tooth (e.g., the occlusal, buccal, and/or lingual surface of the tooth) to mount the cap 1004 onto the tooth. Although FIG. 10A illustrates a cap that extends over most of the tooth surface, in some embodiments, the single-tooth auxiliary positioner may only extend over particular portions of the tooth (e.g., the occlusal side and the lingual side, the occlusal side and the buccal side), e.g., for more flexibility in positioning an auxiliary, to save on material costs, etc.

The positioner 1000a also includes an auxiliary support 1006 formed in the cap 1004 to couple the auxiliary 1002 to the cap 1004. In the illustrated embodiment, the auxiliary support 1006 is a recess (e.g., a pocket, indentation, receptacle) that receives the auxiliary 1002 therein. The auxiliary 1002 can be a separate prefabricated component that is placed into the recess before the cap 1004 is placed on the tooth. When the cap 1004 is placed on the tooth, the auxiliary support 1006 can position the auxiliary 1002 at a predetermined location against a surface of the tooth (e.g., a buccal, lingual, or occlusal surface). The auxiliary 1002 can then be bonded to the tooth (e.g., via an energy-curable adhesive as described herein), and the cap 1004 can then be removed from the tooth to leave the bonded auxiliary 1002 in place.

In some embodiments, the cap 1004 is an elastic and/or self-tightening component that is configured to maintain contact between the auxiliary 1002 and the tooth during bonding. For example, the cap 1004 can have a resting and/or unloaded state in which the volume of the interior cavity of the cap 1004 is smaller than the volume of the corresponding portion of the tooth. To place the cap 1004 on the tooth, the cap 1004 can be expanded (e.g., stretched) from its initial volume to a larger volume so the tooth can fit at least partially into the interior cavity of the cap 1004. The forces generated by the cap 1004 in resisting the expansion to return to its initial volume can secure the cap 1004 onto the tooth. These forces can also apply pressure to the auxiliary 1002 to bias the auxiliary 1002 against the surface of the tooth, which can improve the strength and quality of the bond. The pressure applied by the cap 1004 can be used in combination with or as a substitute for pressure applied to the auxiliary 1002 via an energy applicator (e.g., a light curing wand). This approach may be beneficial to promote secure bonding especially in situations with inaccessible teeth where there is not enough space to bring an energy applicator into direct contact with the auxiliary 1002 (e.g., due to malocclusions, crowding, and/or obstruction by other objects), but may also be used on teeth that are accessible (e.g., to facilitate the bonding process as described below).

In some embodiments, the cap 1004 is entirely or partially made out of a material that provides elastic and/or self-tightening properties, such as shape memory materials (e.g. polymers, metal alloys, foams), or suitable combinations thereof. Alternatively or in combination, the cap 1004 can include structural features that confer elastic and/or self-tightening properties. For example, in the embodiment of FIG. 10A, the cap 1004 includes a compliant mesh, lattice, or spring 1008 formed therein that is elastically deformable to allow the cap 1004 to be stretched to fit onto the tooth. The resistance of the mesh 1008 to the elastic deformation can produce forces that retain the cap 1004 on the tooth and apply pressure to bias the auxiliary 1002 against the tooth. Although the mesh 1008 is depicted as being localized to only a portion of the cap 1004, in other embodiments, the entire cap 1004 can be composed of the mesh 1008.

FIG. 10B is a perspective view of another dental auxiliary positioner 1000b for placing an auxiliary 1012 on a single tooth, in accordance with embodiments of the present technology. The positioner 1000b can be generally similar to the embodiment of FIG. 10A, e.g., the positioner 1000b includes a cap 1014 configured to couple to a tooth, and the cap 1014 includes an auxiliary support 1016 (e.g., a recess) that receives an auxiliary 1012 to be placed on the tooth. As shown in FIG. 10B, the cap 1014 is divided into two (or in some cases, more than two) discrete sections 1018 (e.g., two halves). The two sections 1018 can be coupled to each other via one or more fasteners 1020 (e.g., stitches, sutures, cords, lacing) that are made partially or entirely out of a material with elastic and/or self-tightening properties (e.g., a polymeric material, a shape memory material). When placing the cap 1014 onto a tooth, the fasteners 1020 can be elastically deformed (e.g., stretched) to allow the two sections 1018 to separate from each other, thereby expanding the size of the cap 1014 to fit onto the tooth. The resistance of the fasteners 1020 to the elastic deformation can produce forces that retain the cap 1014 on the tooth and apply pressure to bias the auxiliary 1012 against the tooth.

FIG. 10C is a perspective view of yet another dental auxiliary positioner 1000c for placing an auxiliary 1022 on a single tooth, in accordance with embodiments of the present technology. The positioner 1000c can be generally similar to the embodiments of FIGS. 10A and 10B, e.g., the positioner 1000c includes a cap 1024 configured to couple to a tooth 1030, and the cap 1024 includes an auxiliary support 1026 (e.g., a recess) that receives an auxiliary 1022 to be placed on the tooth 1030. As shown in FIG. 10C, the cap 1024 includes one or more pleated sections 1028 (e.g., accordion folds) that are expandable to allow the cap 1024 to fit onto the tooth 1030. The pleated sections 1028 are part of a band that goes around a circumference of the tooth 1030 so as to retain and bias the auxiliary 1022 against the tooth. The resistance of the pleated sections 1028 to the expansion can produce forces that retain the cap 1024 on the tooth 1030 and apply pressure to bias the auxiliary 1022 against the tooth 1030. Although the illustrated embodiment depicts the cap 1024 with two pleated sections 1028 at opposite sides of the auxiliary support 1026, in other embodiments, the cap 1024 can include fewer or more pleated sections 1028. Optionally, the cap 1024 can include an extension 1031 that wraps around the occlusal surface of the tooth 1030 to cover the other surface of the tooth 1030 (e.g., the lingual surface, if the auxiliary 1022 is placed on the buccal surface; or the buccal surface, if the auxiliary 1022 is placed on the lingual surface).

FIG. 10D is a perspective view of yet another dental auxiliary positioner 1000d for placing an auxiliary 1032 on a single tooth, in accordance with embodiments of the present technology. The positioner 1000d can be generally similar to the embodiments of FIGS. 10A-10C, e.g., the positioner 1000d includes a cap 1034 configured to couple to a tooth, and the cap 1034 includes an auxiliary support 1036 that couples to an auxiliary 1032 to be placed on the tooth. In the embodiment of FIG. 10D, the auxiliary support 1036 includes a plurality of struts 1038 that connect the auxiliary 1032 to the surrounding portions of the cap 1034. The struts 1038 can be formed, for example, by creating a plurality of perforations in the cap 1034 along the perimeter of the auxiliary 1032, with the remaining material between the perforations serving as the struts 1038. Alternatively, the struts can be formed by direct fabrication (e.g., 3D printing) methods, similar to the struts, auxiliaries, and auxiliary positioners described elsewhere herein. The struts 1038 can be breakable to allow the auxiliary 1032 to be released from the cap 1034 after the auxiliary 1032 is bonded to the tooth. This configuration can be used, for example, as an alternative to the recess-type auxiliary supports illustrated in FIGS. 10A-10C.

In some embodiments, one or more single-tooth dental auxiliary positioners (e.g., the positioners described in FIGS. 10A-10D) may be part of a larger positioner system similar to the positioners 300a, 300b, 400, 500, 600, and 900c. For example, instead of a plurality of auxiliary supports with frames for auxiliaries (e.g., auxiliary support 602 as illustrated in FIG. 6), a similar positioner may include a plurality of single-tooth dental auxiliary positioners (e.g., positioners such as 1000a, 1000b, 1000c, and/or 1000d). In some embodiments, a positioner may include auxiliary supports with frames for teeth that are accessible, and single-tooth dental auxiliary positioners for teeth that are inaccessible. In some embodiments, a positioner may include single-tooth dental auxiliary positioners for all teeth, whether or not they are inaccessible. As mentioned above, the single-tooth dental auxiliary positioners may have elastic and/or self-tightening properties (or some other biasing mechanism) that retain and bias auxiliaries against their respective teeth to apply a sufficient pressure to allow for optimal bonding. This facilitates the bonding process (whether or not a tooth is inaccessible) by allowing a practitioner to simply transmit energy toward the auxiliary without having to apply pressure manually. The result is a simpler and faster bonding process, and in some cases a more optimal bonding process (e.g., since the pressure is more controlled and less likely to cause the auxiliary to shift from a manual application of pressure).

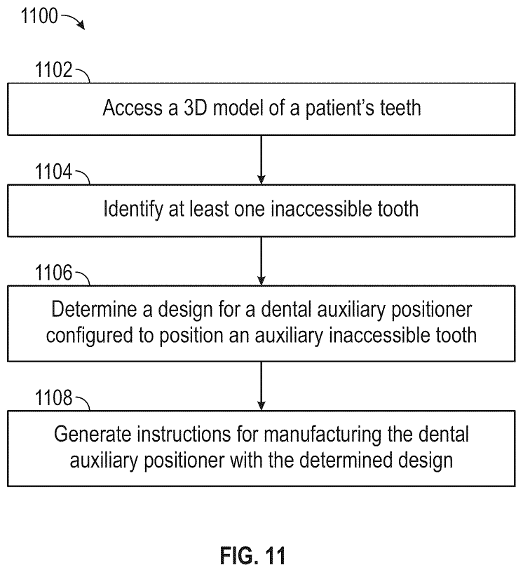

FIG. 11 is a flow diagram illustrating a method 1100 for designing a dental auxiliary positioner for placing a dental auxiliary on a tooth, in accordance with embodiments of the present technology. The method 1100 can be used to design and fabricate any of the dental auxiliary positioners described herein. In some embodiments, some or all of the processes of the method 1100 are implemented as computer-readable instructions (e.g., program code) that are configured to be executed by one or more processors of a computing device, such as a computing device of a treatment planning system, positioner design system, positioner fabrication system, or suitable combinations thereof.

The method 1100 can begin at block 1102 with accessing a 3D model of a patient's teeth. The 3D model can be a 3D digital representation or information configured to render such a representation. For example, the 3D model can be a mesh model, surface model, parametric model, or other model type depicting the 3D shapes and locations of the teeth. In some embodiments, the 3D model shows the patient's teeth in an initial (e.g., pre-treatment) arrangement. The 3D model can be generated using any suitable technique, such as via direct intraoral scanning or scanning of casts, impressions, models, etc., of the teeth.

At block 1104 the method 1100 can include identifying at least one inaccessible tooth of the patient's teeth, based on the 3D model. As described herein, a tooth can be considered to be inaccessible if there is not enough space to place an auxiliary on a surface of the tooth, there is not enough space to fit an auxiliary support proximate to the tooth, there is not enough space to fit a registration element on the crown of the tooth, and/or there is not enough space to fit an energy applicator against the auxiliary to bond the auxiliary to the tooth.

The inaccessible tooth can be identified using various techniques, such as using an automated or semi-automated algorithms (e.g., rule-based algorithms, machine learning algorithms), based on input from a user (e.g., a technician or clinician), or suitable combinations thereof. In some embodiments, the inaccessible tooth is identified by measuring a dimensional parameter of each tooth in the 3D model, such as an amount of exposed surface area on one or more surfaces of the tooth (e.g., a buccal, lingual, and/or occlusal surface), an amount of unobstructed space proximate to one or more surfaces of the tooth (e.g., an amount of unobstructed space at the buccal, lingual, and/or occlusal sides of the tooth), and/or any other parameters indicative of the degree of accessibility of the tooth. The measured dimensional parameter can be compared to a threshold value to determine whether the tooth is considered to be inaccessible. For example, if the amount of exposed surface area on the tooth and/or the amount of unobstructed space proximate to the tooth is less than a threshold value, the tooth can be identified as being an inaccessible tooth.

Alternatively or in combination, the inaccessible tooth is identified by determining an initial design for an auxiliary support configured to position an auxiliary on a tooth, then determining whether the auxiliary support with the initial design is too close to another object proximate to the tooth (e.g., to another tooth, another auxiliary or auxiliary support, or another object in the intraoral cavity). If the auxiliary support is determined to be too close to the object, the tooth can be identified as being inaccessible. In some embodiments, the initial design is a “default” design that is generated without specific features and/or modifications to accommodate other objects proximate to the tooth. The initial design can be considered to be too close to another object if the minimum separation distance between the auxiliary support and the other object is less than a threshold value (e.g., less than 2 mm, 1.5 mm, 1 mm, 0.5 mm, or 0.25 mm), and/or if the other object intersects, collides with, or otherwise obstructs the auxiliary support.

In some embodiments, the process of block 1104 involves determining a first buffer zone around the auxiliary support with the initial design, determining a second buffer zone around an object proximate to the tooth, and determining whether the first and second buffer zones overlap. If the first and second buffer zones overlap, the auxiliary support can be considered to be too close to the object, and thus the tooth can be identified as being inaccessible. The first and second buffer zones can have the same overall shape as the auxiliary support and object, respectively, but with an enlarged size to provide a safety margin between the auxiliary support and the object. For instance, the size of the first and second buffer zones can be 105%, 110%, 115%, 120%, or 125% of the size of the auxiliary support and object, respectively. The size of the buffer zone may be variable depending on the type of object, location within the intraoral cavity, and/or other relevant considerations. For example, the buffer zone can be larger around buttons or other auxiliaries that are manually mounted on the teeth, since such auxiliaries may be relatively small and challenging to place precisely.

At block 1106, the method 1100 can continue with determining a design for a dental auxiliary positioner configured to position an auxiliary on the inaccessible tooth. The positioner can have any of the features of the embodiments disclosed herein. For example, the positioner can include a plurality of registration elements configured to couple to the patient's teeth, and at least one auxiliary support configured to place an auxiliary on the inaccessible tooth. The auxiliary support can be configured to place the auxiliary on a lingual surface of the tooth, e.g., as described with respect to FIGS. 3A and 3B. The auxiliary support can be coupled to a connector that extends from one or more registration elements, rather than coupled directly to a registration element, e.g., as described with respect to FIGS. 4A-6. The auxiliary support can include modifications to accommodate an object that blocks the tooth, e.g., as described with respect to FIGS. 7A-8C. Optionally, the auxiliary support can include features to reduce debris produced when releasing the auxiliary from the auxiliary support, e.g., as described with respect to FIGS. 9A-9C. In some embodiments, the positioner is or includes a cap that fits on a single tooth to place an auxiliary on the tooth, e.g., as described with respect to FIGS. 10A-10D.

At block 1108, the method 1100 can include generating instructions for manufacturing the dental auxiliary positioner with the determined design. For example, the instructions can be used for direct fabrication of the positioner using an additive manufacturing process. Examples of additive manufacturing processes include, but are not limited to, the following: (1) vat photopolymerization and similar processes in which an object is constructed from a vat or other bulk source of liquid resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, the positioner can be fabricated using a combination of two or more additive manufacturing processes.

The method 1100 illustrated in FIG. 11 can be modified in many different ways. For example, some of the processes of the method 1100 can be omitted, such as the process of block 1108. The method 1100 can include additional processes not shown in FIG. 11, such as displaying the positioner with the determined design on an output device, receiving feedback on the design from a user (e.g., a technician or clinician), and/or modifying the design based on the received feedback. Optionally, multiple different designs can be generated and displayed, so the user can compare the designs and select a final design to be used for the positioner.

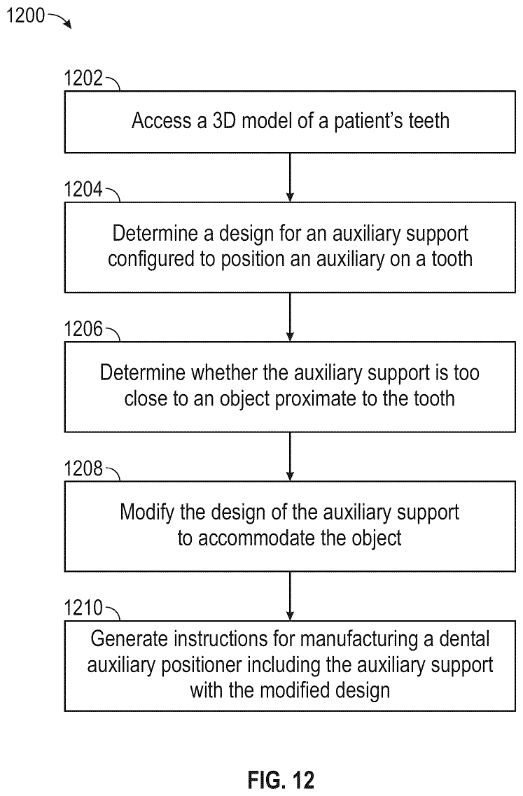

FIG. 12 is a flow diagram illustrating a method 1200 for designing a dental auxiliary positioner for placing an auxiliary on a tooth, in accordance with embodiments of the present technology. The method 1200 can be used in combination with any of the other methods described herein, such as the method 1100 of FIG. 11. In some embodiments, some or all of the processes of the method 1200 are implemented as computer-readable instructions (e.g., program code) that are configured to be executed by one or more processors of a computing device, such as a computing device of a treatment planning system, positioner design system, positioner fabrication system, or suitable combinations thereof.

The method 1200 can begin at block 1202 with accessing a 3D model of a patient's teeth. The process of block 1202 can be identical or similar to the process of block 1102 of the method 1100 of FIG. 11.

At block 1202, the method 1200 can include determining a design for an auxiliary support configured to position an auxiliary on a tooth. The auxiliary support can include any of the features described herein, such as a frame extending partially or entirely around the perimeter of the auxiliary, and one or more struts connecting the auxiliary to the frame. The struts can be breakable struts that are configured to fracture to release the auxiliary from frame, as disclosed herein. In some embodiments, the auxiliary support includes a bridge connecting the frame to another portion of the positioner (e.g., to a registration element or a connector), while in other embodiments, the frame can be directly connected to the other portion of the positioner without any intervening components. Optionally, the design produced in block 1202 can be a “default” design that does not include specific features and/or modifications to accommodate other objects proximate to the tooth.

At block 1204, the method 1200 can continue with determining whether the auxiliary support with the design is too close to an object proximate to the tooth. The object can be another tooth (e.g., a neighboring tooth), another portion of the same positioner that includes the auxiliary support (e.g., another auxiliary, auxiliary support, or registration element of the positioner), another device in the intraoral cavity (e.g., another dental appliance, another auxiliary to be mounted to the same tooth or to a different tooth), or a combination thereof. The auxiliary support can be considered to be too close to the object if the minimum separation distance between the auxiliary support and the object is less than a threshold value (e.g., less than 0.2 mm, 0.15 mm, 0.1 mm, 0.05 mm, or 0.005 mm), and/or if the object intersects, collides with, or otherwise obstructs the auxiliary support.

In some embodiments, the process of block 1204 involves determining a first buffer zone around the auxiliary support with the design, determining a second buffer zone around an object proximate to the tooth, and determining whether the first and second buffer zones overlap. If the first and second buffer zones overlap, the auxiliary support can be considered to be too close to the object, and thus the tooth can be identified as being inaccessible. The first and second buffer zones can have the same overall shape as the auxiliary support and object, respectively, but with an enlarged size to provide a safety margin between the auxiliary support and the object. For instance, the size of the first and second buffer zones can be 105%, 110%, 115%, 120%, or 125% of the size of the auxiliary support and object, respectively. The size of the buffer zone may be variable depending on the type of object, location within the intraoral cavity, and/or other relevant considerations. For example, the buffer zone can be larger around buttons or other auxiliaries that are manually mounted on the teeth, since such auxiliaries may be relatively small and challenging to place precisely.

At block 1208, the method 1200 can include modifying the design of the auxiliary support to accommodate the object. The modification can include removing a portion of the auxiliary support that would otherwise collide or come too close to the object, changing a shape of a portion of the auxiliary support that would otherwise collide or come too close to the object, or a combination thereof. For instance, the modification can include removing a portion of a frame of the auxiliary support and/or changing a shape of a portion of the frame, e.g., as described with respect to FIGS. 7A-8C. In some embodiments, the appropriate modification(s) to be made are determined based on the locations and/or amount of overlap between the first and second buffer zones. For instance, the frame can be trimmed and/or changed in shape at one or more locations where the buffer zones overlap. In some embodiments, relatively small amounts of overlap are corrected by changing the shape of the frame, while relatively large amounts of overlap are corrected by removing a portion of the frame.

Optionally, the method 1200 can include determining whether the auxiliary support with the modified design is still too close to the object, or whether it is sufficiently spaced apart from the object. For example, the method 1200 can check whether the minimum separation distance between the modified auxiliary support and the object exceeds the threshold value. Alternatively or in combination, the method 1200 can determine a third buffer zone around the modified auxiliary support, and can determine whether the third buffer zone overlaps the second buffer zone around the object. If the modified auxiliary support is still too close to the object, the method 1200 can return to block 1208 to further modify the design to accommodate the object. This process can be repeated to iteratively modify the design until a satisfactory design is achieved. Optionally, if a satisfactory design cannot be produced, the method 1200 can generate a notification to a user (e.g., a technician or clinician) indicating that it is not possible to design an auxiliary support for that tooth.

At block 1210, the method 1200 can include generating instructions for manufacturing a dental auxiliary positioner including the auxiliary support with the modified design. The process of block 1210 can be identical or generally similar to the process of block 1108 of the method 1100 of FIG. 11.

The method 1200 illustrated in FIG. 12 can be modified in many different ways. For example, some of the processes of the method 1200 can be omitted, such as the process of block 1210. The method 1200 can include additional processes not shown in FIG. 12, such as displaying the positioner with the modified design on an output device, receiving feedback on the modified design from a user (e.g., a technician or clinician), and/or making further adjustments to the modified design based on the received feedback. Optionally, multiple modified designs can be generated and displayed, so the user can compare the designs and select a final design to be used for the positioner.

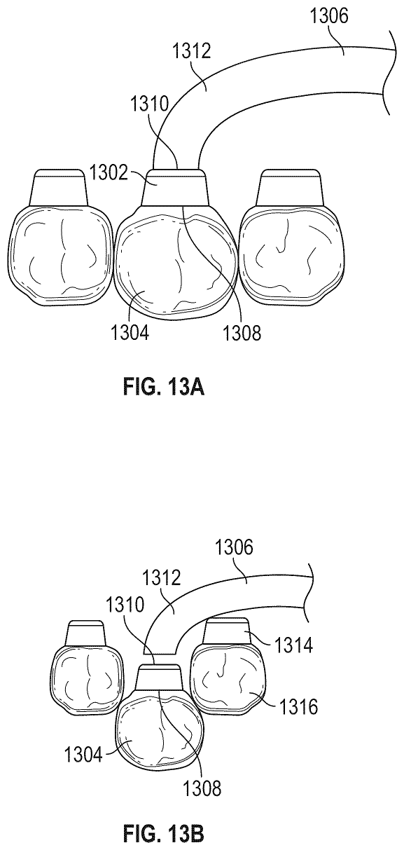

In some embodiments, the present technology provides systems, devices, and methods for mounting an auxiliary to a tooth, such as an inaccessible tooth. For example, FIG. 13A illustrates a process for mounting an auxiliary 1302 to a tooth 1304 using an energy applicator 1306, in accordance with embodiments of the present technology. The auxiliary 1302 can be placed at a predetermined location on the tooth 1304 using a dental appliance, such as any of the attachment placement appliances described herein. In some embodiments, a curable adhesive is applied to a first surface 1308 of the auxiliary 1302 that contacts the surface of the tooth 1304. After the auxiliary 1302 has been placed on the tooth 1304, the energy applicator 1306 (e.g., a curing wand) can be used to output energy (e.g., UV light, visible light, infrared light) that cures the curable adhesive, thereby bonding the auxiliary 1302 to the tooth. As shown in FIG. 13A, the energy applicator 1306 can include an applicator tip 1312 that directs the energy toward the auxiliary 1302 to cure the adhesive at the interface between the auxiliary 1302 and the tooth 1304. In some embodiments, during the curing process, the applicator tip 1312 (or any other suitable device/structure) is used to apply pressure to the auxiliary 1302 to facilitate formation of a secure bond to the tooth. Specifically, the applicator tip 1312 can be brought into contact with a second surface 1310 of the auxiliary 1302 while the applicator tip 1312 applies energy to cure the adhesive at the first surface 1308 of the auxiliary 1302.

In some instances, malocclusions, crowding, and/or the presence of other objects in the intraoral cavity may make it difficult or impossible to access an auxiliary with an energy applicator for curing. For example, FIG. 13B illustrates a tooth arrangement in which access to the auxiliary 1302 on the tooth 1304 is obstructed by a second auxiliary 1314 on a neighboring tooth 1316. Due to the locations of the second auxiliary 1314 and neighboring tooth 1316 relative to the auxiliary 1302 and the tooth 1304, the applicator tip 1312 cannot be brought into direct contact (or at least, it may be difficult to bring the applicator tip 1312 into sufficient direct contact) with the second surface 1310 of the auxiliary 1302 during curing to provide pressure, which may result in poorer or inadequate bonding of the auxiliary 1302 to the tooth 1304. Moreover, it may be challenging to control moisture levels at or proximate to the second surface 1310 of the auxiliary 1302. The presence of moisture due to saliva and/or other intraoral fluids at the interface between the auxiliary 1302 and the tooth 1304 may compromise bonding performance, and this issue is heightened when pressure cannot be applied against the auxiliary to prevent ingress of saliva/fluids at the interface. Isolating the tooth 1304 surface from saliva and/or other intraoral fluids may be time-consuming and ineffective when the tooth 1304 is made inaccessible, e.g., by the neighboring tooth 1316 as shown in FIG. 13B.

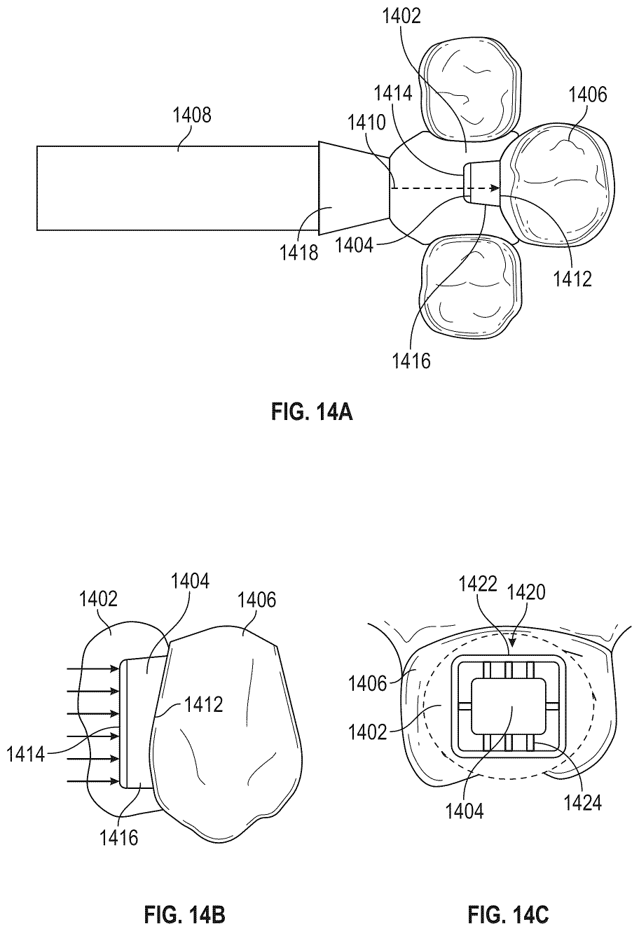

To address these and other challenges, the present technology provides systems, devices, and methods for mounting auxiliaries to teeth that are inaccessible (e.g., difficult to reach) with an energy applicator. Representative examples of such systems, devices, and methods are described below in connection with FIGS. 14A-16. Any of the features of the embodiments of FIGS. 14A-16 can be combined with each other and/or with the features of the other embodiments disclosed herein.

FIGS. 14A-14C are partially schematic top, side, and front views, respectively of a moldable material 1402 applied to an auxiliary 1404 on a tooth 1406, in accordance with embodiments of the present technology. Referring to FIGS. 14A-14C together, the moldable material 1402 can be used to interface between the auxiliary 1404 and an energy applicator 1408 that outputs energy 1410 to bond the auxiliary 1404 to the tooth 1406. The moldable material 1402 can be a putty, gel, paste, etc., that is deformable to conform to the shape of the auxiliary 1404 and tooth surface, and that is sufficiently solid to remain in place once applied and to transfer pressure from the energy applicator (or other device/structure) to the auxiliary. The moldable material 1402 can also be transmissive to the energy 1410 produced by the energy applicator 1408 so that the presence of the moldable material 1402 does not interfere with the curing process, as described in greater detail below.

As best seen in FIGS. 14A and 14B, the auxiliary 1404 can include a first surface 1412 configured to be mounted to the surface of the tooth 1406, a second surface 1414 opposite the first surface, and one or more lateral surfaces 1416 connecting the first surface 1412 to the second surface 1414. The moldable material 1402 can be applied onto the second surface 1414 of the auxiliary 1404 to partially or fully cover the second surface 1414. Optionally, the moldable material 1402 can also partially or fully cover the lateral surfaces 1416 of the auxiliary 1404 and/or the portions of the tooth surface proximate to the auxiliary 1404, thereby forming a barrier around the auxiliary 1404 to isolate the first surface 1412 of the auxiliary 1404 from moisture, which may improve bonding of the auxiliary 1404 to the tooth 1406. The moldable material 1402 can be applied to the auxiliary 1404 manually or using a delivery device (e.g., a syringe). In some embodiments, a delivery device may be coupled to or may be part of the energy applicator 1408 (e.g., with an opening for flowing/extruding the moldable material near the energy applicator tip), such that a single device can be used to apply the moldable material 1402 and to subsequently cure the attachment with the moldable material 1402 in place (e.g., without having to switch to another device and/or without having to move the tip 1418 significantly after delivery of the moldable material 1402). The moldable material 1402 could remain in place until one or more auxiliaries are bonded and would retain the auxiliary supports when the auxiliaries are released from the auxiliary supports, minimizing projectile fragments or debris.

In some embodiments, the first surface 1412 is configured to be bonded to the tooth 1406 via a curable adhesive (e.g., a UV-curable adhesive) interposed between the first surface 1412 and the tooth 1406, as described herein. Accordingly, the energy applicator 1408 can be a curing wand or other similar device that outputs energy 1410 to cure the curable adhesive. For example, the energy applicator 1408 can be a light curing wand that outputs light energy. Alternatively or in combination, the energy applicator 1408 can provide other types of outputs to facilitate curing, such as thermal energy, chemical output, or mechanical output (e.g., pressure). As shown in FIG. 14A, the energy applicator 1408 can include an applicator tip 1418 (e.g., a straight or curved tip) that is brought into direct contact with the moldable material 1402 to apply pressure thereto. At least some of the pressure from the applicator tip 1418 (represented by the arrows in FIG. 14B) can be transmitted by the moldable material 1402 onto the second surface 1414 of the auxiliary 1404, thereby providing forces that hold the auxiliary 1404 against the tooth 1406 during curing to improve bonding to the tooth 1406.

During the curing process, the energy 1410 produced by the energy applicator 1408 can be output from the applicator tip 1418 and directed toward the auxiliary 1404 and the curable adhesive on the first surface 1412 of the auxiliary 1404. For example, the energy 1410 can be light energy, such as UV light, visible light, or infrared light. The parameters of the energy 1410 (e.g., energy type, wavelength, intensity, exposure time) can be selected based on the type of curable adhesive used, type of material used for the auxiliary 1404, amount of bonding strength needed, and/or other relevant considerations. The moldable material 1402 can be configured to receive, guide, and transmit the energy 1410 from the energy applicator 1408 to the auxiliary 1404 with sufficiently high efficiency to allow for curing of the adhesive. For example, the transmission efficiency can be sufficiently high such that at least 50%, 60%, 70%, 80%, 90%, 95%, or 99% of the energy 1410 output by the energy applicator 1408 reaches the auxiliary 1404. In embodiments where the energy 1410 is light energy, the moldable material 1402 can be optically translucent or transparent to the wavelength(s) of light that cure the adhesive, e.g., in embodiments where UV light is used to cure a photo-curable adhesive, the moldable material 1402 can be a UV-transparent material. Examples of energy transmissive materials that may be used as the moldable material 1402 include polydimethylsiloxane (PDMS), polyvinylsiloxane (PVS), PVS-PDMS hybridomers, hydrogels, and combinations (e.g., copolymers, mixtures) thereof.

Referring next to FIG. 14C, in some embodiments, the auxiliary 1404 is placed on the tooth 1406 via an auxiliary support 1420. The auxiliary support 1420 can include, for example, a frame 1422 extending partially or entirely around the auxiliary 1404, and one or more struts 1424 connecting the auxiliary 1404 to the frame 1422. The struts 1424 can be fractured to release the auxiliary 1404 from the auxiliary support 1420 after bonding, as described elsewhere herein. In some embodiments, the moldable material 1402 (depicted using broken lines for purposes of clarity) covers and adheres to the frame 1422 and/or struts 1424) such that any debris produced from breaking the struts 1424 is trapped by the moldable material 1402. Accordingly, when the moldable material 1402 is removed from the auxiliary 1404 and tooth 1406 after the bonding process, the debris can also be removed from the patient's mouth together with the moldable material 1402. This approach can improve safety and user experience when placing auxiliaries using auxiliary supports with breakable components by preventing debris from, e.g., ending up in the oral cavity.

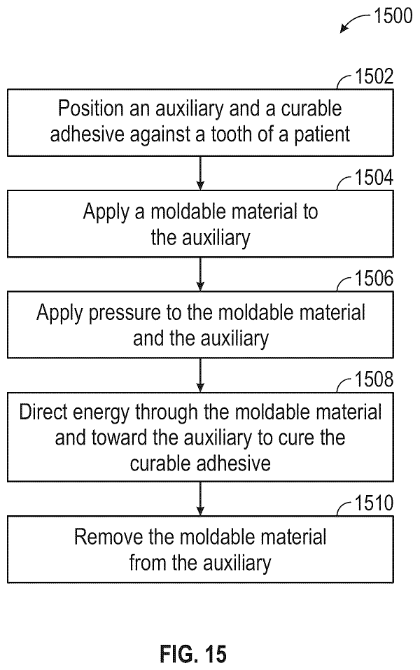

FIG. 15 is a flow diagram illustrating a method 1500 for placing a dental auxiliary on a tooth, in accordance with embodiments of the present technology. The method 1500 can be performed in combination with any of the other methods described herein (e.g., the method 1100 of FIG. 11 and/or the method 1200 of FIG. 12).

The method 1500 can begin at block 1502 with positioning an auxiliary and a curable adhesive against a tooth of a patient. The auxiliary can be placed on the tooth using any of the dental auxiliary positioners described herein. The curable adhesive can be any adhesive suitable for mounting the auxiliary to the tooth, such as a UV-curable adhesive. The curable adhesive can be interposed between the auxiliary and the surface of the tooth, and can be applied to a bonding surface of the auxiliary before the auxiliary is placed on the tooth. In some embodiments, the tooth is inaccessible, such as due to another tooth, due to another portion of the same positioner, and/or due to a dental appliance or object, such that there is insufficient space for an energy applicator (e.g., curing wand) to directly contact the auxiliary.

At block 1504, the method 1500 can include applying a moldable material to the auxiliary. The moldable material (e.g., moldable material 1402 of FIGS. 14A-14C) can be a gel, putty, paste, etc., that contacts and conforms to the auxiliary to provide an interface between the auxiliary and the energy applicator for curing the curable adhesive. As described herein, the moldable material can partially or completely cover the auxiliary to isolate the bonding surface of the auxiliary from intraoral fluids that may interfere with bonding. In some embodiments, the moldable material is applied onto the auxiliary manually, while in other embodiments, the moldable material is applied via a delivery device (e.g., a syringe).

At block 1506, the method 1500 can include applying pressure to the moldable material and the auxiliary. The pressure can be applied, for example, by the energy applicator for curing the curable adhesive. In some embodiments, the process of block 1506 involves using the energy applicator to directly contact and apply pressure to the moldable material. The moldable material can transmit the pressure from the energy applicator onto the auxiliary, thereby applying force against the auxiliary to maintain contact between the auxiliary and tooth surface during bonding.

At block 1508, the method 1500 can continue with directing energy through the moldable material and toward the auxiliary to cure the curable adhesive, thereby bonding the auxiliary to the tooth. The energy (e.g., UV light, visible light, infrared light) can be output by the energy applicator toward the moldable material, and the moldable material can receive and transmit the energy toward the auxiliary. As described herein, the moldable material can be sufficiently transmissive to the energy to avoid interfering with the curing process, e.g., the energy can be transmitted through the moldable material with 50%, 60%, 70%, 80%, 90%, 95%, or 99% efficiency. For instance, the moldable material can be an optically transparent material, such as a UV-transparent material.

At block 1510, the method 1500 can include removing the moldable material from the auxiliary, e.g., after bonding is complete. In some embodiments, the auxiliary is separated from a dental auxiliary positioner before the moldable material is removed, such as fracturing one or more components of the positioner (e.g., breakable struts). In such embodiments, the moldable material can be used to trap and remove debris produced by the fracturing of the positioner.

The method 1500 illustrated in FIG. 15 can be modified in many different ways. For example, some of the processes of the method 1500 can be omitted, such as the process of block 1506. The method 1500 can include additional processes not shown in FIG. 15, and/or the ordering of the processes shown in FIG. 15 can be varied. For instance, the process of blocks 1506 and 1508 can be performed concurrently.

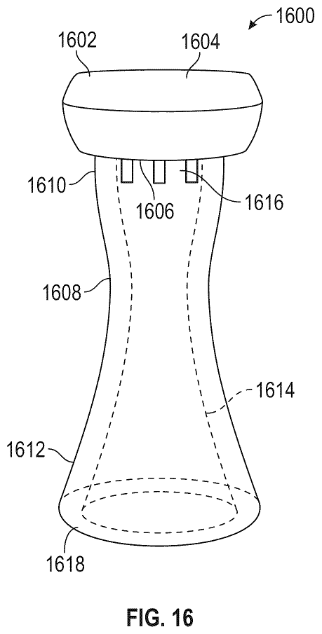

FIG. 16 is a perspective view of a device 1600 including an auxiliary 1602 and an integrated interface 1608 for an energy applicator, in accordance with embodiments of the present technology. The device 1600 can be used, for example, when the auxiliary 1602 cannot be directly accessed by the energy applicator (e.g., the auxiliary 1602 is placed on an inaccessible tooth). As shown in FIG. 16, the auxiliary 1602 includes a first surface 1604 configured to be mounted to a tooth, and a second surface 1606 opposite the first surface 1604. The interface 1608 can be an elongate, hollow structure (e.g., a tube) including a first end portion 1610 coupled to the auxiliary 1602, a second end portion 1612 opposite the first end portion 1610, and a lumen 1614 extending between the first end portion 1610 and the second end portion 1612. In some embodiments, the first end portion 1610 includes one or more struts 1616 that are connected to the first surface 1604 of the auxiliary 1602. The struts 1616 can be fractured to release the auxiliary 1602 from the interface 1608 after the auxiliary 1602 has been bonded onto a tooth, e.g., similar to the struts of the auxiliary supports disclosed herein.

The lumen 1614 of the interface 1608 can allow energy produced by an energy applicator (e.g., a curing wand) to be directed toward the auxiliary 1602 to cure a curable adhesive for bonding the auxiliary 1602 to a tooth, as described elsewhere herein. The second end portion 1612 can be configured to engage the energy applicator during the bonding process to allow the energy applicator to indirectly apply pressure onto the auxiliary 1602. As shown in FIG. 16, the second end portion 1612 can include a surface 1618 (e.g., an annular surface) that is configured to receive and directly contact an applicator tip of the energy applicator. Accordingly, pressure applied by the applicator tip to the second end portion 1612 of the interface 1608 can be transmitted onto the auxiliary 1602, thereby exerting forces on the auxiliary 1602 to facilitate bonding of the auxiliary 1602 to a tooth, as disclosed herein.

In some embodiments, the interface 1608 is integrally formed with the auxiliary 1602, e.g., the interface 1608 and auxiliary 1602 can be fabricated together in a single manufacturing operation (e.g., via a single additive manufacturing process). Alternatively, the interface 1608 and auxiliary 1602 can be discrete components that are fabricated separately (e.g., via separate additive manufacturing processes) and subsequently assembled to form the device 1600, e.g., the interface 1608 can be fabricated in a separate operation and subsequently coupled to the auxiliary 1602 using adhesives, fasteners, mechanical fixation, etc.

The device 1600 can be used with a dental auxiliary positioner that serves as a template for placing the auxiliary 1602 onto the tooth at predetermined location. In such embodiments, the positioner can include a registration element with a cavity formed therein to receive the tooth. The registration element can be a cap that fits onto a single tooth or can be one of a plurality of registration elements that couple to a corresponding plurality of the patient's teeth, as described elsewhere herein. In some embodiments, the registration element includes a recess (e.g., a cutout) formed therein to guide placement of the auxiliary 1602 onto the tooth. For instance, the recess can have a shape complementary to the shape of the auxiliary 1602, such that the auxiliary 1602 can be positioned at the appropriate location on the tooth by inserting the auxiliary 1602 into the recess.

Although certain embodiments of the devices and methods provided herein are described in connection with placement of auxiliaries on inaccessible teeth, this is not intended to be limiting. Any of the embodiments described herein (e.g., in connection with FIGS. 3A-16) can also be used for placement of auxiliaries on teeth that are not considered to be inaccessible.

In some instances, correct placement of an auxiliary on a tooth may be challenging if the geometry of the dental auxiliary positioner does not sufficiently match the teeth geometry, e.g., if the registration elements do not fit properly on the teeth, if the size and shape of the auxiliary support does not place the auxiliary at the correct location on the tooth, etc. Such issues may arise, for example, due to inaccuracies in the data used to design the dental auxiliary positioner (e.g., errors in intraoral scan data), inaccuracies in the digital design of the positioner, and/or inaccuracies in the manufacturing of the positioner (e.g., if the actual geometry of the manufactured positioner does not match the intended design). Poor auxiliary placement may cause insufficient contact between the auxiliary and the tooth surface, which may result in a weaker bond and/or gaps between the auxiliary and tooth surface after bonding. Additionally, improper auxiliary placement may cause insufficient and/or incorrect forces to be applied to the teeth by a dental appliance, may make it challenging and/or uncomfortable to seat the dental appliance over the auxiliary, and/or may result in breaking or displacement of the auxiliary during dental appliance placement or removal.

To address these and other issues, the present technology provides dental auxiliary positioners with a controlled degree of flexibility to allow the clinician to adjust the position of the auxiliary relative to the tooth, e.g., to compensate for fit errors and/or to ensure sufficient tooth contact for bonding purposes. In some embodiments, the dental auxiliary positioner includes an auxiliary support including a flexible bridge (e.g., a bendable elongate shaft) coupling the auxiliary to the registration element, where the flexible bridge can be moved (e.g., bent, translated, rotated) in one or more directions (e.g., a mesial-distal direction, a buccal-lingual direction, and/or an occlusal-gingival direction) to adjust the auxiliary. Moreover, the auxiliary may be coupled to the flexible bridge via one or more struts and a frame, and the design of the struts and frame can be configured to allow the auxiliary to be easily released from the auxiliary support after bonding with little or no loose debris. Other advantages of the flexible auxiliary supports described herein may include increased durability and/or printability (e.g., the auxiliary support is more likely to withstand forces applied thereto during additive manufacturing of the dental auxiliary positioner).

FIG. 17A is a side view of a portion of a dental auxiliary positioner 1700a including flexible auxiliary supports 1702, and FIG. 17B is a perspective view of an individual auxiliary support 1702 of the positioner 1700a, in accordance with embodiments of the present technology.

Referring first to FIG. 17A, the positioner 1700a can be generally similar to the other embodiments of positioners described herein. For instance, the positioner 1700a can include a plurality of registration elements 1704 that are configured to receive and couple to a patient's teeth. Each registration element 1704 can include a cavity defining an inner surface that engages at least a portion of the occlusal, buccal, and/or lingual surfaces of a respective tooth to mount the registration element 1704 onto the tooth. The positioner 1700a also includes a plurality of auxiliary supports 1702 that are each configured to position a corresponding auxiliary 1706 at a predetermined location against or proximate to a surface of a tooth when the positioner 1700a is placed on the patient's teeth. Each auxiliary support 1702 can be coupled to a corresponding registration element 1704 that receives the tooth to which the auxiliary 1706 is to be mounted, such that when the registration element 1704 engages the tooth, the auxiliary 1706 is positioned at or proximate to a target location on the tooth surface (e.g., a buccal surface, a lingual surface, an occlusal surface).

As best seen in FIG. 17B, the auxiliary support 1702 includes a frame 1708 that extends partially around the perimeter of the auxiliary 1706, a plurality of struts 1710 coupling the auxiliary 1706 to the frame 1708, and a flexible bridge 1712 coupling the frame 1708 to the registration element 1704. The flexible bridge 1712 can be bendable in one or more direction relative to the registration element 1704 and the received tooth, such as a mesial-distal direction, a buccal-lingual direction, and/or an occlusal-gingival direction. The bending of the flexible bridge 1712 can produce a corresponding shift in the position of the frame 1708 and auxiliary 1706, thereby allowing the auxiliary 1706 to be repositioned relative to the underlying tooth. Optionally, the flexible bridge 1712 can be configured to allow for other types of movements for repositioning the auxiliary 1706, such as rotation of the frame 1708 and auxiliary 1706 relative to the flexible bridge 1712.

In the illustrated embodiment, the flexible bridge 1712 is a curved elongate shaft (e.g., a curved trunk) including a first end 1714a coupled to the registration element 1704, a second end 1714b coupled to the frame 1708, and a curved body 1716 between the first end 1714a and the second end 1714b. The second end 1714b may be narrower than the first end 1714a, or vice-versa, or both ends 1714a, 1714b may have the same width and/or diameter.

At least a portion of the curved body 1716 can extend laterally outward away from the registration element 1704 (the term “extend laterally outward” encompasses both extending in a lateral direction only, as well as extending in both lateral and vertical directions). For example, the portion of the curved body 1716 proximate to the first end 1714a can curve upward and laterally outward away from the registration element 1704. The portion of the curved body 1716 proximate to the second end 1714b can curve upward and laterally inward toward the received tooth. The curvature of the curved body 1716 can be configured to allow for bending of the flexible bridge 1712, e.g., in a buccal-lingual direction. For example, the clinician may press the auxiliary 1706 and/or flexible bridge 1712 toward the surface of the tooth to ensure sufficient contact for bonding purposes and/or to reduce the likelihood of gaps between the bonded auxiliary 1706 and the tooth surface. Alternatively or in combination, the flexible bridge 1712 can also be moved in other directions, such as in a mesial-distal direction. The registration element 1704 can optionally include a recess 1720 formed in the surface proximate to the flexible bridge 1712 to accommodate motion of the flexible bridge 1712, e.g. bending of the flexible bridge 1712 inward toward the registration element 1704 and/or in a mesial-distal direction along the registration element 1704.

In some embodiments, the positioner 1700a is configured to constrain the repositioning of the auxiliary 1706 to a predetermined range of locations. The predetermined range can be sufficiently large so that minor adjustments to the auxiliary 1706 can be made, but sufficiently small to prevent the auxiliary 1706 from being adjusted to a location that is too far from the predetermined target location on the tooth. In some embodiments, the predetermined range is no more than 0.5 mm, 0.4 mm, 0.3 mm, 0.2 mm, or 0.1 mm away from the predetermined target location (e.g., in a buccal-lingual direction, mesial-distal direction, and/or gingival-occlusal direction). The repositioning of the auxiliary 1706 may be constrained via various techniques, such as based on the geometry (e.g., length, diameter, width, curvature) of the flexible bridge 1712, the material properties (e.g., stiffness) of the flexible bridge 1712, and/or the geometry (e.g., size, shape) of the recess 1720 in the registration element 1704.

The auxiliary support 1702 can alternatively or additionally be configured to reduce or eliminate debris produced when the auxiliary 1706 is released from the auxiliary support 1702. As described elsewhere herein, the auxiliary 1706 may be released after bonding to the tooth by fracturing the struts 1710, thereby allowing the positioner 1700a to be removed while the auxiliary 1706 remains in place on the tooth. The auxiliary support 1702 can be designed so that the frame 1708, struts 1710, and flexible bridge 1712 remain connected to each other after the auxiliary 1706 is released, thus avoiding the creation of loose debris. For instance, the frame 1708 can extend only partially around the auxiliary 1706 (e.g., be U-shaped or C-shaped) such that a gap 1722 is present in the frame 1708. The gap 1722 can be located at an upper side of the frame 1708, opposite the side that is coupled to the flexible bridge 1712, which may reduce the likelihood of the frame 1708 fracturing, e.g., as previously discussed with respect to FIG. 9A. Moreover, the lower side of the frame 1708 may be curved to reduce stress concentration at the connection between the frame 1708 and the flexible bridge 1712. Additionally, the angle of the pair of struts 1710a adjacent to the gap 1722 can be configured to concentrate stress at or near the interface between the struts 1710a and the auxiliary 1706, as will be discussed further below in connection with FIGS. 18A-18E.

FIG. 17C is a perspective view of a portion of a dental auxiliary positioner 1700b including flexible auxiliary supports 1752, and FIG. 17D is a perspective view of an individual auxiliary support 1752 of the positioner 1700b, in accordance with embodiments of the present technology.

Referring first to FIG. 17C, the positioner 1700b can be generally similar to the other embodiments of positioners described herein, such as the positioner 1700a of FIGS. 17A and 17B. For instance, the positioner 1700b can include a plurality of registration elements 1754 that are configured to receive and couple to a patient's teeth, and a plurality of auxiliary supports 1752 that are each coupled to respective registration element 1754 and are each configured to position a corresponding auxiliary 1756 at a predetermined location against or proximate to a surface of a tooth when the positioner 1700b is placed on the patient's teeth.

As best seen in FIG. 17D, the auxiliary support 1752 includes a frame 1758 that extends partially around the perimeter of the auxiliary 1756, a plurality of struts 1760 coupling the auxiliary 1756 to the frame 1758, and a flexible bridge 1762 coupling the frame 1758 to the registration element 1754. The auxiliary support 1752 can be generally similar to the auxiliary support 1702 of FIGS. 17A and 17B, except as noted below.

In the embodiment of FIGS. 17C and 17D, the flexible bridge 1762 is a straight elongate shaft (e.g., a straight trunk) including a first end 1764a coupled to the registration element 1754, a second end 1764b coupled to the frame 1758, and a linear body 1766 between the first end 1764a and the second end 1764b. The second end 1764b may be narrower than the first end 1764a, or vice-versa, or both ends 1764a, 1764b may have the same width and/or diameter.

At least a portion of the linear body 1766 can extend laterally outward away from the registration element 1754. For example, the portion of the linear body 1766 proximate to the first end 1764a can be angled laterally outward away from the registration element 1754 (e.g., at an angle of at least from vertical). The portion of the linear body 1766 proximate to the second end 1764b may also be angled laterally outward, may extend vertically upward, or may be angled laterally inward toward the tooth. The geometry of the linear body 1766 can be configured to allow for 5°, 10°, 15°, 20°, 30°, 40°, or 450 bending of the flexible bridge 1762 in a buccal-lingual direction. Alternatively or in combination, the flexible bridge 1762 can also be moved in other directions, such as in a mesial-distal direction.

Similar to the positioner 1700a of FIGS. 17A and 17B, the positioner 1700b may be configured to constrain the repositioning of the auxiliary 1756 to a predetermined range of locations (e.g., no more than 0.5 mm, 0.4 mm, 0.3 mm, 0.2 mm, or 0.1 mm away from a predetermined target location in a buccal-lingual direction, mesial-distal direction, and/or gingival-occlusal direction). The repositioning of the auxiliary 1756 may be constrained via various techniques, such as based on the geometry (e.g., length, diameter, width, angle) of the flexible bridge 1762 and/or the material properties (e.g., stiffness) of the flexible bridge 1762.

The auxiliary support 1752 can alternatively or additionally be configured to reduce or eliminate debris produced when the auxiliary 1756 is released from the auxiliary support 1752. As described elsewhere herein, the auxiliary 1756 may be released after bonding to the tooth by fracturing the struts 1760, thereby allowing the positioner 1750a to be removed while the auxiliary 1756 remains in place on the tooth. The auxiliary support 1752 can be designed so that the frame 1758, struts 1760, and flexible bridge 1762 remain connected to each other after the auxiliary 1756 is released, thus avoiding the creation of loose debris. For instance, the frame 1758 can extend only partially around the auxiliary 1756 (e.g., be U-shaped or C-shaped) such that a gap 1768 is present in the frame 1758. The gap 1768 can be located at an upper side of the frame 1758, opposite the side that is coupled to the flexible bridge 1762, which may reduce the likelihood of the frame 1758 fracturing, e.g., as previously discussed with respect to FIG. 9A. Moreover, the lower side of the frame 1758 may be curved to reduce stress concentration at the connection between the frame 1758 and the flexible bridge 1762. Additionally, the angle of the pair of struts 1760a adjacent to the gap 1722 can be configured to concentrate stress at or near the interface between the struts 1760a and the auxiliary 1756, as will be discussed further below in connection with FIGS. 18A-18E.

In some embodiments, the auxiliary support 1752 includes features that are advantageous for positioning the auxiliary 1756 on a lingual surface of a tooth. For example, the frame 1758 may be curved and/or folded to reduce the overall size of the auxiliary support 1752, which may be beneficial for fitting into the limited space at the lingual side of the tooth. Moreover, the cross-sectional thickness of the struts 1760 and/or flexible bridge 1762 can be varied to provide enhanced strength (e.g., in the buccal-lingual direction) to withstand forces applied by the patient's tongue. In other embodiments, however, the auxiliary support 1752 may be used to position the auxiliary 1756 on other surfaces of a tooth, such as a buccal surface or an occlusal surface. Moreover, other types of auxiliary supports may be used to position an auxiliary on a lingual surface of a tooth, such as the auxiliary support 1702 of FIGS. 17A and 17B.

In some embodiments, the auxiliary supports described herein include one or more breakable struts that fracture to release the auxiliary when the dental auxiliary positioner is removed from the patient's teeth. The components of the auxiliary support can be designed so that the forces applied to the auxiliary and auxiliary support during removal of the dental auxiliary positioner from the teeth result in stress concentration at or proximate to the interface between the struts and the auxiliary, such that the auxiliary support fractures only at the interface and not at other locations that might produce loose debris (e.g., the frame, bridge).

FIG. 18A illustrates removal of a dental auxiliary positioner 1800 from a patient's teeth 1802, in accordance with embodiments of the present technology. As indicated by the arrow in FIG. 18A, the positioner 1800 may be rotated in a lingual-to-buccal direction during the removal process, which may result in different forces being applied to the auxiliaries and auxiliary supports on the lingual side of the positioner 1800 versus on the buccal side of the positioner 1800. In some embodiments, at least some of the struts of an auxiliary support of the positioner 1800 are offset from (e.g., perpendicular to) the axis of rotation of the positioner 1800 in order to increase or maximize stress concentration at the appropriate locations.

FIG. 18B is a partially schematic illustration of struts 1810 coupled to an auxiliary 1812 at a positive angle, in accordance with embodiments of the present technology. The struts 1810 are coupled to the upper side of the auxiliary 1812 and may be adjacent to a gap in a frame surrounding the auxiliary 1812 (e.g., similar to the struts 1710a in FIG. 17B—the frame is omitted in FIG. 18B merely for purposes of simplicity). In the illustrated embodiment, each strut 1810 is at a positive angle A₁ relative to the upper side of the auxiliary 1812, e.g., the struts 1810 are located partially or entirely above the auxiliary 1812 and are angled downward to connect to the auxiliary 1812. The positive angle A₁ may be at least 5°, 10°, 15°, 20°, 30°, 40°, 45°, 50°, 60°, 70°, 800 or 90°; and/or may be within a range from 5° to 45°, or from 450 to 80°.

FIG. 18C is a partially schematic illustration of struts 1820 coupled to an auxiliary 1822 at a negative angle, in accordance with embodiments of the present technology. The struts 1820 are coupled to the upper side of the auxiliary 1822 and may be adjacent to a gap in a frame surrounding the auxiliary 1822 (e.g., similar to the struts 1760a in FIG. 17D—the frame is omitted in FIG. 18C merely for purposes of simplicity). In the illustrated embodiment, each strut 1820 is at a negative angle A₂ relative to the upper side of the auxiliary 1822, e.g., the struts 1820 are located partially or entirely below the auxiliary 1822 and are angled upward to connect to the auxiliary 1822. The negative angle A₂ may be at least 5°, 10°, 15°, 20°, 30°, 40°, 45°, 50°, 60°, 70°, 800 or 90°; and/or may be within a range from 5° to 45°, or from 450 to 80°.

FIG. 18D is a partially schematic illustration of stresses applied to a buccal auxiliary support 1830 during positioner removal, in accordance with embodiments of the present technology. The buccal auxiliary support 1830 is connected to a registration element 1832 of a dental auxiliary positioner and is configured to position an auxiliary 1834 on a buccal surface of a tooth T (certain elements of the auxiliary support 1830 such as the frame and bridge are omitted from the illustration for simplicity). The auxiliary support 1830 can include one or more struts 1836 (e.g., a pair of struts, three struts positioned radially around the auxiliary 1834, etc.) located gingival to the auxiliary 1834, each strut 1836 having a gingival end 1838 and an occlusal end 1840 (a single strut 1836 is shown in FIG. 18D for purposes of simplicity). The occlusal end 1840 can be connected to the auxiliary 1834 at a strut-auxiliary interface P₁ and the gingival end 1838 can be coupled to the frame of the auxiliary support 1830 (not shown) at a strut-frame interface P₂. Stated differently, the strut-auxiliary interface P₁ can be positioned occlusally relative to the strut-frame interface P₂, such that the strut 1836 is at a positive angle relative to the auxiliary 1834. During removal of the positioner from the tooth T, the registration element 1832 may be rotated in a lingual-to-buccal direction around a center of rotation C. The torque from the rotation of the registration element 1832 is transmitted to the auxiliary support 1830, frame, and strut 1836 (vector V represents the moment arm from the center of rotation R to the strut-frame interface P₂), thus producing a corresponding rotation of the strut 1836 in a buccal-to-lingual direction around the strut-auxiliary interface P₁. As a result, stresses generated by positioner removal may be concentrated at the strut-auxiliary interface P₁ rather than at the strut-frame interface P₂, thus increasing the likelihood of the auxiliary support 1830 fracturing at the strut-auxiliary interface P₁ only.

FIG. 18E is a partially schematic illustration of stresses applied to a lingual auxiliary support 1840 during positioner removal, in accordance with embodiments of the present technology. The lingual auxiliary support 1850 is connected to a registration element 1852 of a dental auxiliary positioner and is configured to position an auxiliary 1854 on a lingual surface of a tooth T (certain elements of the auxiliary support 1850 such as the frame and bridge are omitted from the illustration for simplicity). The auxiliary support 1850 can include one or more struts 1856 (e.g., a pair of struts, three struts positioned radially around the auxiliary 1834, etc.) located gingival to the auxiliary 1854, each strut 1856 having a gingival end 1858 and an occlusal end 1860 (a single strut 1856 is shown in FIG. 18E for purposes of simplicity). The occlusal end 1860 can be connected to the auxiliary 1534 and the gingival end 1858 can be coupled to a frame 1852 of the auxiliary support 1850. Stated differently, the strut-auxiliary interface P₁ can be positioned occlusally relative to the strut-frame interface P₂, such that the strut 1856 is at a positive angle relative to the auxiliary 1854. During removal of the positioner from the tooth T, the registration element 1852 may be rotated in a lingual-to-buccal direction around a center of rotation C. The torque from the rotation of the registration element 1852 is transmitted to the auxiliary support 1850, frame, and strut 1856 (vector V represents the moment arm from the center of rotation R to the strut-frame interface P₂), thus producing a corresponding rotation of the strut 1856 in a buccal-to-lingual direction around the strut-auxiliary interface P₁, such that the strut 1856 is at a positive angle relative to the auxiliary 1854. As a result, stresses generated by positioner removal may be concentrated at the strut-auxiliary interface P₁ rather than at the strut-frame interface P₂, thus increasing the likelihood of the auxiliary support 1850 fracturing at the strut-auxiliary interface P₁ only.

In some embodiments, the present technology provides methods for designing a dental auxiliary positioner for placing an auxiliary on a patient's tooth, where the positioner includes one or more auxiliary supports that are designed based on location, e.g., whether the auxiliary support is intended to place an auxiliary on a buccal surface or a lingual surface of a tooth. As discussed herein, certain configurations may be more suitable for buccal placement in some instances (e.g., the embodiments of FIGS. 17A and 17B) while other configurations may be more suitable for lingual placement in some instances (e.g., the embodiments of FIGS. 17C and 17D). In some embodiments, the design process involves selecting a design template for an auxiliary support based on whether the auxiliary support is to be positioned on the buccal surface or on the lingual surface, where the design template includes features (e.g., strut angles, strut locations, frame shapes, bridge shapes) that are known to be advantageous for buccal or lingual placement. The design template can subsequently be customized to the particular patient's tooth shape, auxiliary geometry, etc.

Alternatively or in combination, the design process can involve identifying forces that would be applied to the auxiliary and/or auxiliary support when the dental auxiliary positioner is removed from the teeth, and then determining a design for the auxiliary support based on the identified forces. For instance, features such as strut angles, strut locations, frame shapes, bridge shapes, etc., can be selected and/or optimized such that the applied forces concentrate stress at the strut-auxiliary interface. The forces may be identified using various techniques, such as simulations, modeling, experimental data, data from previous positioner designs, etc.

Optionally, the design process may include determining an auxiliary support configuration that enhances contact between the auxiliary and the tooth surface, e.g., to avoid gaps between the auxiliary and tooth surface that may compromise bond quality. In some embodiments, the design process involves identifying a surface of the tooth where the auxiliary is to be positioned, then determining a geometry for the auxiliary support that positions the auxiliary with a negative offset from the surface of the tooth. Stated differently, the auxiliary support can be designed to position the tooth-contacting surface of the auxiliary at a spatial location that is inwardly offset from the surface of the tooth, rather than being aligned with the surface of the tooth. The offset amount can be, for example, at least 10 μm, 25 μm, 50 μm, 75 μm, 100 μm, 150 μm, or 200 μm; and/or within a range from 10 μm to 50 μm, 50 μm to 100 μm, 100 μm to 150 μm, or 50 μm to 150 μm. Accordingly, when the dental auxiliary positioner is placed on the patient's teeth, the negative offset can result in the auxiliary support applying “self-retentive” force to the auxiliary that biases the auxiliary against the tooth surface, thereby enhancing contact for bonding purposes. The negative offset can also reduce the likelihood of gaps between the auxiliary and the tooth due to surface mismatch between the auxiliary and tooth.

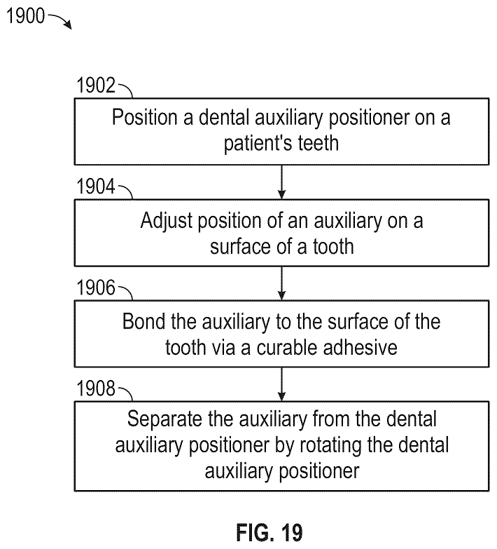

FIG. 19 is a flow diagram illustrating a method 1900 for placing a dental auxiliary on a patient's tooth, in accordance with embodiments of the present technology. The method 1900 can be implemented using any of the devices described herein, and may be performed in combination with any of the other methods described herein.

The method 1900 can begin at block 1902 with positioning a dental auxiliary positioner on a patient's teeth. The dental auxiliary positioner can be any of the embodiments described herein (e.g., with respect to FIGS. 17A-18E). For instance, the dental auxiliary positioner can include at least one registration element configured to receive a tooth, and an auxiliary support coupled to the registration element and further coupled to an auxiliary. The auxiliary support can include a frame extending at least partially around the auxiliary, one or more struts coupling the auxiliary to the frame, and a flexible bridge coupling the frame to the registration element.

At block 1904, the method 1900 can include adjusting a position of an auxiliary on a surface of a tooth using the dental auxiliary positioner. In some embodiments, the position is adjusted by moving (e.g., bending, rotating, translating) the flexible bridge of the auxiliary support connected to the auxiliary, e.g., in a buccal-lingual direction, a mesial-distal direction, an occlusal-gingival direction, etc. As described herein, the movement of the flexible bridge can optionally be constrained to a predetermined range to prevent the auxiliary from being adjusted too far from the target location on the tooth.

At block 1906, the method 1900 can include bonding the auxiliary to the surface of the tooth via a curable adhesive. The bonding process can include using an energy applicator (e.g., a curing wand) to apply energy (e.g., UV light, visible light, infrared light) toward the curable adhesive (e.g., a UV-curable compound) to bond the auxiliary to the tooth surface using the curable adhesive. Optionally, pressure may be applied to the auxiliary during the bonding process to maintain good contact with the curable adhesive and the tooth surface.

At block 1908, the method 1900 can continue with separating the auxiliary from the dental auxiliary positioner by rotating the dental auxiliary positioner. For instance, the dental auxiliary positioner may be rotated relative to the patient's teeth (e.g., in a lingual-to-buccal direction as shown in FIG. 18A) to apply stresses to the auxiliary support that cause the auxiliary support to release the auxiliary, e.g., by fracturing one or more struts connecting the auxiliary to the rest of the auxiliary support. As discussed herein, the auxiliary support can be designed to concentrate stress at the appropriate locations of the auxiliary support (e.g., the strut-auxiliary interface) to avoid the creation of loose debris.

### II. Dental Appliances and Associated Methods

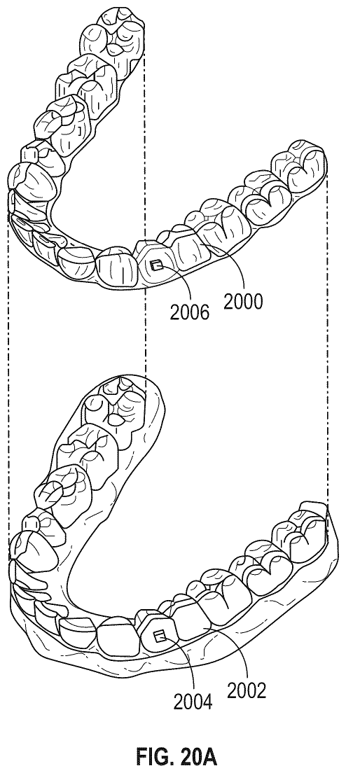

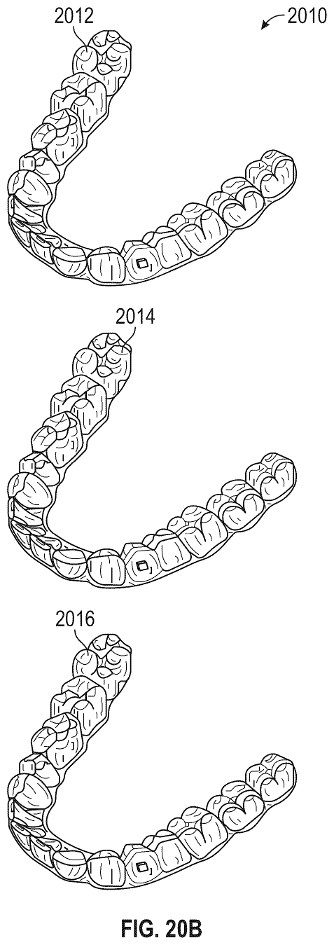

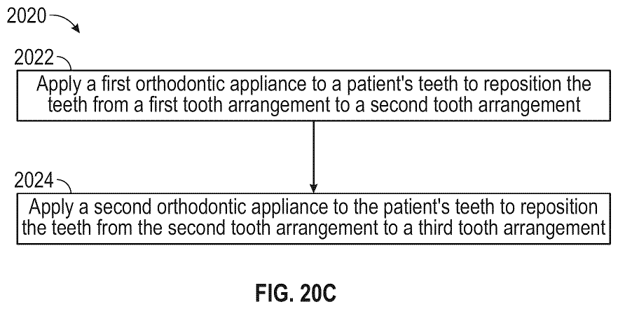

FIG. 20A illustrates a representative example of a tooth repositioning appliance 2000 configured in accordance with embodiments of the present technology. The appliance 2000 can be used in combination with any of the systems, methods, and devices described herein. The appliance 2000 (also referred to herein as an “aligner”) can be worn by a patient in order to achieve an incremental repositioning of individual teeth 2002 in the jaw. The appliance 2000 can include a shell (e.g., a continuous polymeric shell or a segmented shell) having teeth-receiving cavities that receive and resiliently reposition the teeth. The appliance 2000 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 2000 can fit over all teeth present in an upper or lower jaw, or less than all of the teeth. The appliance 2000 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 2000 can be a generic appliance configured to receive the teeth, but not necessarily shaped to match the topography of the patient's teeth. In some cases, only certain teeth received by the appliance 2000 are repositioned by the appliance 2000 while other teeth can provide a base or mounting region for holding the appliance 2000 in place as it applies force against the tooth or teeth targeted for repositioning. In some cases, some, most, or even all of the teeth can be repositioned at some point during treatment. Teeth that are moved can also serve as a base or mounting region for holding the appliance as it is worn by the patient. In preferred embodiments, no wires or other means are provided for holding the appliance 2000 in place over the teeth. In some cases, however, it may be desirable or necessary to provide individual attachments 2004 or other auxiliaries (e.g., buttons) on teeth 2002 with corresponding receptacles 2006 or apertures in the appliance 2000 so that the appliance 2000 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 20B illustrates a tooth repositioning system 2010 including a plurality of appliances 2012, 2014, 2016, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 2010 can include a first appliance 2012 corresponding to an initial tooth arrangement, one or more intermediate appliances 2014 corresponding to one or more intermediate arrangements, and a final appliance 2016 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 20C illustrates a method 2020 of orthodontic treatment using a plurality of appliances, in accordance with embodiments of the present technology. The method 2020 can be practiced using any of the appliances or appliance sets described herein. In block 2022, a first orthodontic appliance is applied to a patient's teeth in order to reposition the teeth from a first tooth arrangement to a second tooth arrangement. In block 2024, a second orthodontic appliance is applied to the patient's teeth in order to reposition the teeth from the second tooth arrangement to a third tooth arrangement. The method 2020 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

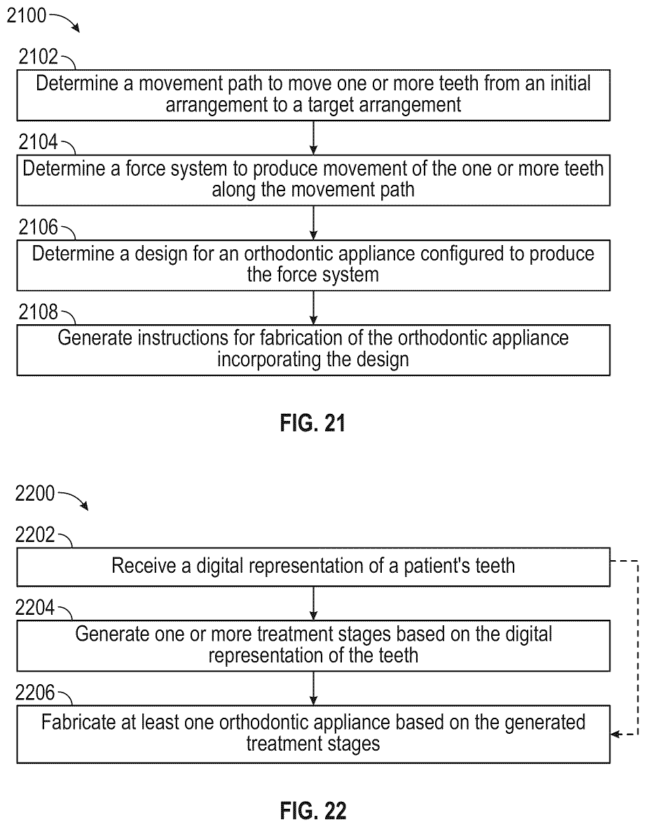

FIG. 21 illustrates a method 2100 for designing an orthodontic appliance, in accordance with embodiments of the present technology. The method 2100 can be applied to any embodiment of the orthodontic appliances described herein. Some or all of the steps of the method 2100 can be performed by any suitable data processing system or device, e.g., one or more processors configured with suitable instructions.

In block 2102, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 2104, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 2104 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 2106, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systemes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 2108, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 2100 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 2100 may be performed with any suitable fabrication system or device, such as the embodiments described herein. Some of the steps may be optional, e.g., the process of block 2104 can be omitted, such that the orthodontic appliance is designed based on the desired tooth movements and/or determined tooth movement path, rather than based on a force system. Moreover, the order of the steps can be varied as desired.

FIG. 22 illustrates a method 2200 for digitally planning an orthodontic treatment and/or design or fabrication of an appliance, in accordance with embodiments. The method 2200 can be applied to any of the treatment procedures described herein and can be performed by any suitable data processing system.

In block 2202 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 2204, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 2206, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 22, design and/or fabrication of an orthodontic appliance, and perhaps a particular orthodontic treatment, may include use of a representation of the patient's teeth (e.g., including receiving a digital representation of the patient's teeth (block 2202)), followed by design and/or fabrication of an orthodontic appliance based on a representation of the patient's teeth in the arrangement represented by the received representation.

The embodiments herein may be used in combination with aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The embodiments herein may be used in combination with incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A dental auxiliary positioner for placing a dental auxiliary on a tooth, the dental auxiliary positioner comprising:
a registration element configured to receive a patient's tooth; and
an auxiliary support coupled to the registration element and further coupled to an auxiliary, wherein the auxiliary support is configured to position the auxiliary against a surface of the tooth, and wherein the auxiliary support comprises:
   a frame extending at least partially around the auxiliary, one or more struts coupling the auxiliary to the frame, and
   a flexible bridge coupling the frame to the registration element, wherein the flexible bridge is configured to bend in one or more directions relative to the tooth to adjust the position of the auxiliary on the surface of the tooth.

Example 2. The dental auxiliary positioner of Example 1, wherein the flexible bridge comprises an elongate shaft having at least a portion that extends laterally away from the registration element.

Example 3. The dental auxiliary positioner of Example 1 or 2, wherein the flexible bridge is curved between the registration element and the frame.

Example 4. The dental auxiliary positioner of any one of Examples 1 to 3, wherein the flexible bridge comprises a first end coupled to the registration element and a second end coupled to the frame, the second end being narrower than the first end.

Example 5. The dental auxiliary positioner of any one of Examples 1 to 4, wherein the one or more directions comprise a buccal-lingual direction, a mesial-distal direction, or a combination thereof.

Example 6. The dental auxiliary positioner of any one of Examples 1 to 5, further comprising a recess formed in a surface of the registration element proximate to the flexible bridge, wherein the recess is configured to accommodate the bending of the flexible bridge in the one or more directions.

Example 7. The dental auxiliary positioner of Example 6, wherein the flexible bridge is configured to constrain the position of the auxiliary on the surface of the tooth to a predetermined range.

Example 8. The dental auxiliary positioner of Example 7, wherein the predetermined range comprises a set of locations no more than 0.3 mm away from a predetermined location of the auxiliary on the tooth.

Example 9. The dental auxiliary positioner of any one of Examples 1 to 8, wherein the frame extends only partially around the auxiliary.

Example 10. The dental auxiliary positioner of any one of Examples 1 to 9, wherein the frame comprises a first side coupled to the flexible bridge and a second side of the frame opposite the first side, and wherein a gap is present in the second side of the frame.

Example 11. The dental auxiliary positioner of Example 10, wherein the one or more struts comprise a pair of struts positioned adjacent to the gap in the frame, wherein each strut of the pair of struts is oriented at an angle relative to the auxiliary, and wherein the angle is configured to concentrate stress at or near an interface between each strut and the auxiliary when the dental auxiliary positioner is removed from the tooth.

Example 12. The dental auxiliary positioner of Example 10 or 11, wherein the one or more struts comprise a pair of struts positioned adjacent to the gap in the frame, wherein each strut of the pair of struts is oriented at an angle relative to the auxiliary, and wherein the dental auxiliary positioner is configured to be rotated in a lingual-to-buccal direction to remove the dental auxiliary positioner from the tooth, and the angle is substantially perpendicular to an axis of the rotation.

Example 13. The dental auxiliary positioner of any one of Examples 10 to 12, wherein the one or more struts comprise a pair of struts positioned adjacent to the gap in the frame, wherein each strut of the pair of struts is oriented at an angle relative to the auxiliary, and wherein the angle is a positive angle.

Example 14. The dental auxiliary positioner of any one of Examples 10 to 13, wherein the one or more struts comprise a pair of struts positioned adjacent to the gap in the frame, and wherein an interface between each strut and the auxiliary is positioned occlusally of an interface between the strut and the frame.

Example 15. The dental auxiliary positioner of any one of Examples 1 to 14, wherein when the tooth is received within the registration element, the auxiliary support positions the auxiliary at a predetermined location on the tooth.

Example 16. The dental auxiliary positioner of any one of Examples 1 to 15, wherein the auxiliary is configured to engage a dental appliance to maintain or apply a force to the tooth.

Example 17. The dental auxiliary positioner of any one of Examples 1 to 16, wherein the auxiliary comprises an attachment, button, power arm, splint, distalizer, bracket, or wire.

Example 18. The dental auxiliary positioner of any one of Examples 1 to 17, further comprising a plurality of registration elements configured to receive a plurality of the patient's teeth.

Example 19. A computer-implemented method for designing a dental auxiliary positioner for placing a dental auxiliary on a tooth, the computer-implemented method comprising, by one or more processors:
accessing a 3D model of a patient's teeth;
determining a design for a dental auxiliary positioner configured to position an auxiliary on a tooth of the patient's teeth, wherein the dental auxiliary positioner comprises the dental auxiliary positioner of any one of Examples 1 to 18; and
generating instructions for manufacturing the dental auxiliary positioner with the determined design.

Example 20. The computer-implemented method of Example 19, wherein the instructions are configured to cause an additive manufacturing system to fabricate the dental auxiliary positioner via an additive manufacturing process.

Example 21. The computer-implemented method of Example 20, further comprising fabricating the dental auxiliary positioner via the additive manufacturing process.

Example 22. The computer-implemented method of any one of Examples 19 to 21, where determining the design comprises:
identifying a surface of the tooth where the auxiliary is to be positioned, and
determining a geometry for the auxiliary support that positions the auxiliary with a negative offset from the surface of tooth.

Example 23. The computer-implemented method of any one of Examples 19 to 22, wherein determining the design comprises:
determining whether the auxiliary is to be positioned on a buccal surface or a lingual surface of the tooth, and
selecting a design template for the auxiliary support based on whether the auxiliary support is to be positioned on the buccal surface or the lingual surface.

Example 24. The computer-implemented method of any one of Examples 19 to 23, where determining the design comprises:
identifying a force applied to the auxiliary during removal of the dental auxiliary positioner from the tooth, and
determining an angle for at least one of the one or more struts based on the identified force.

Example 25. A method for placing a dental auxiliary on a tooth, the method comprising:
positioning an auxiliary against a tooth of a patient by placing a dental auxiliary positioner on the patient's teeth, wherein the dental auxiliary positioner comprises:
   a registration element configured to receive the tooth, and an auxiliary support comprising:
      a frame extending at least partially around the auxiliary,
      one or more struts coupling the auxiliary to the frame, and
      a flexible bridge coupling the frame to the registration element,
bending the flexible bridge to position the auxiliary at a target location on a surface of the tooth;
bonding the auxiliary to the target location on the surface of the tooth via a curable adhesive; and
separating the auxiliary from the dental auxiliary positioner by rotating the dental auxiliary positioner relative to the patient's teeth, wherein the rotating causes the one or more struts to release the auxiliary.

Example 26. The method of Example 25, wherein the rotating causes the one or more struts to fracture to release the auxiliary.

Example 27. The method of Example 26, wherein the one or more struts fracture at or proximate to a respective interface between each strut and the auxiliary.

Example 28. The method of Example 26 or 27, wherein the registration element, the frame, the one or more struts, and the flexible bridge remain coupled to each other after the one more struts are fractured.

Example 29. The method of any one of Examples 25 to 28, wherein the flexible bridge comprises an elongate shaft having at least a portion that extends laterally away from the registration element.

Example 30. The method of any one of Examples 25 to 29, wherein the flexible bridge is curved between the registration element and the frame.

Example 31. The method of any one of Examples 25 to 30, wherein the flexible bridge comprises a first end coupled to the registration element and a second end coupled to the frame, the second end being narrower than the first end.

Example 32. The method of any one of Examples 25 to 31, wherein the flexible bridge is bent in a buccal-lingual direction, a mesial-distal direction, or a combination thereof.

Example 33. The method of any one of Examples 25 to 32, wherein the dental auxiliary positioner further comprising a recess formed in a surface of the registration element proximate to the flexible bridge, wherein the recess is configured to accommodate the bending of the flexible bridge.

Example 34. The method of any one of Examples 25 to 33, wherein the flexible bridge is configured to constrain the position of the auxiliary on the surface of the tooth to a predetermined range during the bending.

Example 35. The method of Example 34, wherein the predetermined range comprises a set of locations no more than 0.3 mm away from a predetermined location of the auxiliary on the tooth.

Example 36. The method of any one of Examples 25 to 35, wherein the frame extends only partially around the auxiliary.

Example 37. The method of any one of Examples 25 to 36, wherein the frame comprises a first side coupled to the flexible bridge and a second side of the frame opposite the first side, and wherein a gap is present in the second side of the frame.

Example 38. The method of Example 37, wherein the one or more struts comprise a pair of struts positioned adjacent to the gap in the frame, wherein each strut of the pair of struts is oriented at an angle relative to the auxiliary, and wherein the angle is configured to concentrate stress at or near an interface between each strut and the auxiliary when the dental auxiliary positioner is removed from the tooth.

Example 39. The method of Example 37 or 38, wherein the one or more struts comprise a pair of struts positioned adjacent to the gap in the frame, wherein each strut of the pair of struts is oriented at an angle relative to the auxiliary, and wherein the dental auxiliary positioner is rotated in a lingual-to-buccal direction to remove the dental auxiliary positioner from the tooth, and the angle is substantially perpendicular to an axis of the rotation.

Example 40. The method of any one of Examples 37 to 39, wherein the one or more struts comprise a pair of struts positioned adjacent to the gap in the frame, wherein each strut of the pair of struts is oriented at an angle relative to the auxiliary, wherein the angle is a positive angle.

Example 41. The method of any one of Examples 37 to 40, wherein the one or more struts comprise a pair of struts positioned adjacent to the gap in the frame, and wherein an interface between each strut and the auxiliary is positioned occlusally of an interface between the strut and the frame.

Example 42. The method of any one of Examples 25 to 41, wherein when the tooth is received within the registration element, the auxiliary support positions the auxiliary at a predetermined location on the tooth.

Example 43. The method of any one of Examples 25 to 42, wherein the auxiliary is configured to engage a dental appliance to maintain or apply a force to the tooth.

Example 44. The method of any one of Examples 25 to 43, wherein the auxiliary comprises an attachment, button, power arm, splint, distalizer, bracket, or wire.

Example 45. The method of any one of Examples 25 to 44, wherein the dental auxiliary positioner comprises a plurality of registration elements configured to receive a plurality of the patient's teeth.

Example 46. A dental auxiliary positioner for placing a dental auxiliary on a tooth, the dental auxiliary positioner comprising:
a registration element configured to receive a patient's tooth;
a connector coupled to the registration element and extending toward a lingual surface of the tooth received by the registration element; and
an auxiliary support coupled to the connector and further coupled to an auxiliary, wherein the auxiliary support is configured to position the auxiliary against the lingual surface of the tooth.

Example 47. The dental auxiliary positioner of Example 46, wherein a buccal surface of the tooth is made inaccessible by one or more neighboring teeth, soft tissue, another auxiliary, or a dental appliance.

Example 48. The dental auxiliary positioner of Example 46, further comprising a second auxiliary support coupled to the registration element and further coupled to a second auxiliary, wherein the second auxiliary support is configured to position the second auxiliary against a buccal surface of the tooth.

Example 49. The dental auxiliary positioner of any one of Examples 46 to 48, wherein the registration element comprises an inner surface configured to engage an occlusal surface of the tooth, and the connector is offset from the surface of the tooth.

Example 50. The dental auxiliary positioner of any one of Examples 46 to 49, wherein the connector does not contact the tooth.

Example 51. The dental auxiliary positioner of any one of Examples 46 to 50, wherein when the tooth is received within the registration element, the auxiliary support positions the auxiliary at a predetermined location on the lingual surface of the tooth.

Example 52. The dental auxiliary positioner of any one of Examples 46 to 51, wherein the auxiliary support comprises:
a frame extending at least partially around the auxiliary, one or more struts coupling the auxiliary to the frame, and a bridge coupling the frame to the connector.

Example 53. The dental auxiliary positioner of Example 52, wherein the one or more struts are configured to release the auxiliary from the auxiliary support.

Example 54. The dental auxiliary positioner of Example 52 or 53, wherein the bridge extends from the connector.

Example 55. The dental auxiliary positioner of any one of Examples 46 to 54, wherein the auxiliary is configured to engage a dental appliance to retain or apply a force to the tooth.

Example 56. The dental auxiliary positioner of any one of Examples 46 to 55, wherein the auxiliary comprises an attachment, button, power arm, splint, distalizer, bracket, or wire.

Example 57. The dental auxiliary positioner of any one of Examples 46 to 56, further comprising a plurality of registration elements configured to receive a plurality of the patient's teeth.

Example 58. A dental auxiliary positioner for placing a dental auxiliary on a tooth, the dental auxiliary positioner comprising:
a registration element configured to receive a first tooth of a patient;
a connector coupled to the registration element; and
an auxiliary support coupled to the connector and further coupled to an auxiliary, wherein the auxiliary support is configured to position the auxiliary against a second tooth,
wherein the dental auxiliary positioner does not include a registration element for the second tooth.

Example 59. The dental auxiliary positioner of Example 58, wherein the first tooth makes the second tooth inaccessible.

Example 60. The dental auxiliary positioner of Example 58 or 59, wherein the connector is configured to be positioned proximate to a buccal surface or a lingual surface of the second tooth.

Example 61. The dental auxiliary positioner of any one of Examples 58 to 60, wherein the connector is configured to be spaced apart from an occlusal surface of the second tooth.

Example 62. The dental auxiliary positioner of any one of Examples 58 to 61, wherein the auxiliary support comprises one or more struts coupled to the auxiliary, and wherein the one or more struts are configured to release the auxiliary from the auxiliary support.

Example 63. The dental auxiliary positioner of Example 62, wherein the auxiliary support further comprises a frame extending at least partially around the auxiliary, and wherein the one or more struts couple the auxiliary to the frame.

Example 64. The dental auxiliary positioner of Example 63, wherein the auxiliary support further comprises a bridge coupling the frame to the connector.

Example 65. The dental auxiliary positioner of any one of Examples 58 to 64, wherein the auxiliary support is integrally formed with the connector.

Example 66. The dental auxiliary positioner of any one of Examples 58 to 64, wherein the auxiliary support is a discrete component that is coupled to the connector.

Example 67. The dental auxiliary positioner of Example 66, wherein the connector comprises a plurality of openings configured to receive the auxiliary support.

Example 68. The dental auxiliary positioner of any one of Examples 58 to 67, wherein the auxiliary support comprises a compliant mechanism configured to permit movement of the auxiliary support relative to the connector within a predetermined movement range.

Example 69. The dental auxiliary positioner of any one of Examples 58 to 68, wherein the auxiliary is configured to engage a dental appliance to retain or apply a force to the second tooth.

Example 70. The dental auxiliary positioner of any one of Examples 58 to 69, wherein the auxiliary comprises an attachment, button, power arm, splint, distalizer, bracket, or wire.

Example 71. The dental auxiliary positioner of any one of Examples 58 to 70, wherein the registration element is a first registration element, and wherein the dental auxiliary positioner further comprises a second registration element configured to receive a third tooth of the patient.

Example 72. The dental auxiliary positioner of Example 71, wherein the connector is coupled to the second registration element.

Example 73. The dental auxiliary positioner of Example 71 or 72, wherein the second tooth is between the first tooth and the third tooth, and wherein the connector extends between the first registration element and the second registration element.

Example 74. The dental auxiliary positioner of Example 73, wherein the dental auxiliary positioner does not include any registration elements between the first registration element and the second registration element.

Example 75. The dental auxiliary positioner of any one of Examples 58 to 74, further comprising a plurality of registration elements configured to receive a plurality of the patient's teeth.

Example 76. A computer-implemented method for designing a dental auxiliary positioner for placing a dental auxiliary on a tooth, the computer-implemented method comprising, by one or more processors:
accessing a 3D model of a patient's teeth;
identifying an inaccessible tooth of the patient's teeth based on the 3D model;
determining a design for a dental auxiliary positioner configured to position an auxiliary on the inaccessible tooth, wherein the dental auxiliary positioner comprises the dental auxiliary positioner of any one of Examples 46 to 68; and
generating instructions for manufacturing the dental auxiliary positioner with the determined design.

Example 77. The computer-implemented method of Example 76, wherein identifying the inaccessible tooth comprises:
measuring an amount of access to a tooth of the 3D model, and
determining whether the amount of exposed surface area is less than a threshold value.

Example 78. The computer-implemented method of Example 76 or 77, wherein identifying the inaccessible tooth comprises:
determining a design for an auxiliary support configured to position an auxiliary on a tooth, and
determining whether the auxiliary support with the design is too close to an object proximate to the tooth.

Example 79. The computer-implemented method of Example 78, wherein determining whether the auxiliary support with the design is too close to the object comprises:
determining a first buffer zone around the auxiliary support with the design,
determining a second buffer zone around the object, and
determining whether the first and second buffer zones intersect.

Example 80. A system for designing a dental auxiliary positioner for placing a dental auxiliary on a tooth, the system comprising:
one or more processors; and
a memory operably coupled to the one or more processors and storing instructions that, when executed by the one or more processors, cause the system to perform the computer-implemented method of any one of Examples 76 to 79.

Example 81. A non-transitory computer-readable storage medium comprising instructions that, when executed by one or more processors of a computing system, cause the computing system to perform the computer-implemented method of any one of Examples 76 to 79.

Example 82. A dental auxiliary positioner for placing a dental auxiliary on a tooth, the dental auxiliary positioner comprising:
a registration element configured to receive a patient's tooth; and
an auxiliary support coupled to the registration element and further coupled to an auxiliary, wherein the auxiliary support comprises:
   a frame extending at least partially around the auxiliary, wherein the frame is configured to accommodate an object that makes the tooth inaccessible, and
   one or more struts coupling the auxiliary to the frame.

Example 83. The dental auxiliary positioner of Example 82, wherein the object that makes the tooth inaccessible comprises a second tooth proximate to the tooth.

Example 84. The dental auxiliary positioner of Example 82 or 83, wherein the object that makes the tooth inaccessible comprises another portion of the dental auxiliary positioner.

Example 85. The dental auxiliary positioner of Example 84, wherein the object that makes the tooth inaccessible comprises another auxiliary support of the dental auxiliary positioner.

Example 86. The dental auxiliary positioner of any one of Examples 82 to 85, wherein the object that makes the tooth inaccessible comprises a second auxiliary configured to be mounted on the tooth.

Example 87. The dental auxiliary positioner of Example 86, wherein the second auxiliary is a dental feature configured to receive an elastic.

Example 88. The dental auxiliary positioner of any one of Examples 82 to 87, wherein the frame comprises a gap that is configured to accommodate the object that makes the tooth inaccessible.

Example 89. The dental auxiliary positioner of any one of Examples 82 to 87, wherein the frame comprises a curved portion that is configured to accommodate the object that makes the tooth inaccessible.

Example 90. The dental auxiliary positioner of Example 89, wherein the curved portion is configured to guide placement of a device to be mounted on the tooth.

Example 91. The dental auxiliary positioner of any one of Examples 82 to 90, wherein when the dental auxiliary positioner is placed on the patient's teeth, the auxiliary support is spaced apart from the object that makes the tooth inaccessible by a distance of at least 0.08 mm.

Example 92. The dental auxiliary positioner of any one of Examples 82 to 91, wherein when the tooth is received within the registration element, the auxiliary support positions the auxiliary at a predetermined location on the tooth.

Example 93. The dental auxiliary positioner of any one of Examples 82 to 92, wherein the auxiliary is configured to engage a dental appliance to retain or apply a force to the tooth.

Example 94. The dental auxiliary positioner of any one of Examples 82 to 93, wherein the auxiliary comprises an attachment, button, power arm, splint, distalizer, bracket, or wire.

Example 95. The dental auxiliary positioner of any one of Examples 82 to 94, further comprising a plurality of registration elements configured to receive a plurality of the patient's teeth.

Example 96. A computer-implemented method for designing a dental auxiliary positioner for placing a dental auxiliary on a tooth, the computer-implemented method comprising, by one or more processors:
accessing a 3D model of a patient's teeth;
determining a design for an auxiliary support configured to position an auxiliary on a tooth of the patient's teeth;
determining whether the auxiliary support with the design is too close to an object proximate to the tooth;
in response to a determination that the auxiliary support with the design is too close to the object, modifying the design of the auxiliary support to accommodate the object; and
generating instructions for manufacturing a dental auxiliary positioner including the auxiliary support with the modified design.

Example 97. The computer-implemented method of Example 96, wherein the auxiliary support comprises:
a frame extending at least partially around the auxiliary, and
one or more struts coupling the auxiliary to the frame.

Example 98. The computer-implemented method of Example 97, wherein the design is modified by modifying the frame.

Example 99. The computer-implemented method of Example 98, wherein the frame is modified by removing a portion of the frame.

Example 100. The computer-implemented method of Example 98 or 99, wherein the frame is modified by changing a shape of a portion of the frame.

Example 101. The computer-implemented method of Example 100, wherein the object is a second auxiliary to be mounted on the tooth, and the changed shape of the portion of the frame is configured to guide placement of the second auxiliary on the tooth.

Example 102. The computer-implemented method of Example 101, wherein the second auxiliary is a dental feature configured to receive an elastic.

Example 103. The computer-implemented method of any one of Examples 96 to 102, wherein the object comprises a second tooth.

Example 104. The computer-implemented method of any one of Examples 96 to 103, wherein the object comprises another portion of the dental auxiliary positioner.

Example 105. The computer-implemented method of any one of Examples 96 to 104, wherein the object comprises a second auxiliary configured to be mounted on the tooth.

Example 106. The computer-implemented method of any one of Examples 96 to 105, wherein determining whether the auxiliary support with the design is too close to the object comprises:
determining a first buffer zone around the auxiliary support with the design,
determining a second buffer zone around the object, and
determining whether the first and second buffer zones overlap.

Example 107. The computer-implemented method of Example 106, wherein the design of the auxiliary support is modified based on one or more of an overlap amount or an overlap location between the first and second buffer zones.

Example 108. The computer-implemented method of Example 106 or 107, further comprising:
determining a third buffer zone around the auxiliary support with the modified design, and
determining whether the first and third buffer zones intersect.

Example 109. The computer-implemented method of any one of Examples 96 to 108, wherein the modified design complies with one or more manufacturability constraints.

Example 110. A system for designing a dental auxiliary positioner for placing a dental auxiliary on a tooth, the system comprising:
one or more processors; and
a memory operably coupled to the one or more processors and storing instructions that, when executed by the one or more processors, cause the system to perform the computer-implemented method of any one of Examples 96 to 109.

Example 111. A non-transitory computer-readable storage medium comprising instructions that, when executed by one or more processors of a computing system, cause the computing system to perform the computer-implemented method of any one of Examples 96 to 109.

Example 112. A dental auxiliary positioner for placing a dental auxiliary on a tooth, the dental auxiliary positioner comprising:
a registration element configured to receive a patient's tooth; and
an auxiliary support coupled to the registration element and further coupled to an auxiliary, wherein:
   the auxiliary support is configured to position the auxiliary against the tooth,
   the auxiliary support comprises one or more breakable struts coupled to the auxiliary, and
   the one or more breakable struts are configured to reduce debris produced when the auxiliary is released from the auxiliary support.

Example 113. The dental auxiliary positioner of Example 112, wherein the auxiliary support further comprises a frame extending at least partially around the auxiliary, and the one or more breakable struts couple the auxiliary to the frame.

Example 114. The dental auxiliary positioner of Example 113, wherein the one or more breakable struts are configured to fracture to release the auxiliary from the auxiliary support without fracturing the frame.

Example 115. The dental auxiliary positioner of Example 113 or 114, wherein the frame comprises a gap.

Example 116. The dental auxiliary positioner of Example 115, wherein the frame comprises a first side coupled to the registration element, and the gap is located in a second side of the frame opposite the first side.

Example 117. The dental auxiliary positioner of Example 115 or 116, wherein the frame comprises a gingival side and an occlusal side, and the gap is located at the gingival side of the frame.

Example 118. The dental auxiliary positioner of any one of Examples 115 to 117, wherein the one or more struts comprise a pair of struts positioned adjacent to the gap in the frame.

Example 119. The dental auxiliary positioner of Example 112, wherein the auxiliary support further comprises a bridge that is coupled to the registration element, and wherein the one or more breakable struts extend directly from the bridge of the auxiliary support without any frame extending around the auxiliary.

Example 120. The dental auxiliary positioner of any one of Examples 112 to 119, wherein when the tooth is received within the registration element, the auxiliary support positions the auxiliary at a predetermined location on the tooth.

Example 121. The dental auxiliary positioner of any one of Examples 112 to 120, wherein the auxiliary is configured to engage a dental appliance to maintain or apply a force to the tooth.

Example 122. The dental auxiliary positioner of any one of Examples 112 to 121, wherein the auxiliary comprises an attachment, button, power arm, splint, distalizer, bracket, or wire.

Example 123. The dental auxiliary positioner of any one of Examples 112 to 122, further comprising a plurality of registration elements configured to receive a plurality of the patient's teeth.

Example 124. A dental auxiliary positioner for placing a dental auxiliary on a tooth, the dental auxiliary positioner comprising:
a plurality of registration elements configured to receive a patient's teeth; and
a plurality of auxiliary supports, wherein:
   each auxiliary support is coupled to a registration element of the plurality of registration elements and further coupled to an auxiliary, and is configured to position the auxiliary against a tooth received by the registration element, and
   each auxiliary support comprises one or more breakable struts coupled to the auxiliary; and
one or more frame connectors coupling the frames of neighboring auxiliary supports to each other.

Example 125. The dental auxiliary positioner of Example 124, wherein the one or more frame connectors comprises one or more elongate members, elastics, wires, ribbons, or crossbars.

Example 126. A dental auxiliary positioner for placing a dental auxiliary on a tooth, the dental auxiliary positioner comprising:
a registration element configured to receive a patient's tooth; and
an auxiliary support coupled to the registration element and further coupled to an auxiliary, wherein:
   the auxiliary support is configured to position the auxiliary against the tooth, and
   the auxiliary support comprises one or more breakable struts coupled to the auxiliary, wherein each breakable strut includes a first end portion connected to the auxiliary and a second end portion connected to a bridge.

Example 127. A system for placing auxiliary on a tooth, the system comprising:
a dental auxiliary positioner comprising an auxiliary configured to be mounted on a tooth via a curable adhesive, wherein the auxiliary is releasably coupled to the dental auxiliary positioner; and
a moldable material configured to be positioned between the auxiliary and an energy applicator, wherein the moldable material is configured to receive and transmit energy produced by the energy applicator toward the auxiliary to cure the curable adhesive, and wherein the moldable material is configured to receive and transmit pressure applied by the energy applicator onto the auxiliary.

Example 128. The system of Example 127, wherein the moldable material is a putty or gel.

Example 129. The system of Example 127 or 128, wherein the moldable material comprises polydimethylsiloxane, polyvinylsiloxane, or a combination thereof.

Example 130. The system of any one of Examples 128 to 129, wherein the auxiliary comprises a first surface configured to be mounted to the tooth and a second surface oriented away from the tooth, and the moldable material is configured to be positioned on the second surface.

Example 131. The system of any one of Examples 127 to 130, wherein the moldable material is configured to cover the auxiliary to isolate the auxiliary from intraoral fluids.

Example 132. The system of any one of Examples 127 to 131, wherein the energy applicator is configured to deliver one or more of light energy, thermal energy, chemical output, or mechanical output.

Example 133. The system of any one of Examples 127 to 132, further comprising the energy applicator.

Example 134. The system of Example 133, wherein the energy applicator is a light curing wand.

Example 135. The system of Example 133 or 134, wherein the energy applicator comprises:
an energy source configured to produce the energy, and
an applicator tip configured to direct the energy toward the auxiliary.

Example 136. The system of Example 135, wherein the applicator tip comprises a surface that is configured to contact and apply the pressure to the moldable material.

Example 137. The system of any one of Examples 127 to 136, further comprising a delivery device for the moldable material.

Example 138. The system of any one of Examples 127 to 137, wherein the dental auxiliary positioner comprises:
one or more registration elements configured to receive one or more teeth, and
an auxiliary support coupled to a registration element of the one or more registration elements and further coupled to the auxiliary, wherein the auxiliary support is configured to position the auxiliary against the tooth.

Example 139. The system of Example 138, wherein the auxiliary support comprises:
a frame extending at least partially around the auxiliary,
one or more struts coupling the auxiliary to the frame, and
a bridge coupling the frame to the connector.

Example 140. The system of Example 138 or 139, wherein when the tooth is received within the registration element, the auxiliary support positions the auxiliary at a predetermined location on the tooth.

Example 141. The system of any one of Examples 127 to 140, wherein the auxiliary is configured to engage a dental appliance to retain or apply a force to the tooth.

Example 142. The system of any one of Examples 127 to 141, wherein the auxiliary comprises an attachment, button, power arm, splint, distalizer, bracket, or wire.

Example 143. A method for placing a dental auxiliary on a tooth, the method comprising:
positioning an auxiliary against a tooth of a patient by placing a dental auxiliary positioner comprising the auxiliary on the patient's teeth, wherein a curable adhesive is interposed between the auxiliary and the tooth;
applying a moldable material to the auxiliary;
bonding the auxiliary to the tooth via a curable adhesive by directing energy through the moldable material and toward the auxiliary to cure the curable adhesive; and
separating the auxiliary from the dental auxiliary positioner.

Example 144. The method of Example 143, wherein the moldable material is a putty or gel.

Example 145. The method of Example 143 or 144, wherein the moldable material comprises polydimethylsiloxane, polyvinylsiloxane, or a combination thereof.

Example 146. The method of any one of Examples 143 to 145, wherein the auxiliary comprises a first surface configured to be mounted to the tooth and a second surface oriented away from the tooth, and the moldable material is applied to the second surface.

Example 147. The method of any one of Examples 143 to 146, further comprising covering the auxiliary with the moldable material to isolate the auxiliary from intraoral fluids.

Example 148. The method of any one of Examples 143 to 147, wherein the energy is output by an energy applicator.

Example 149. The method of Example 148, wherein the energy applicator is configured to deliver one or more of light energy, thermal energy, chemical output, or mechanical output.

Example 150. The method of Example 149, further comprising contacting the moldable material with the energy applicator.

Example 151. The method of Example 149 or 150, further comprising applying pressure to the auxiliary via the energy applicator and the moldable material while outputting energy from the energy applicator.

Example 152. The method of any one of Examples 149 to 151, wherein the tooth is inaccessible such that there is insufficient space to position the energy applicator directly against the auxiliary.

Example 153. The method of any one of Examples 143 to 152, wherein the dental auxiliary positioner comprises:
one or more registration elements configured to receive one or more teeth, and
an auxiliary support coupled to a registration element of the one or more registration elements and further coupled to the auxiliary, wherein the auxiliary support is configured to position the auxiliary against the tooth.

Example 154. The method of Example 153, wherein the auxiliary support comprises:
a frame extending at least partially around the auxiliary,
one or more struts coupling the auxiliary to the frame, and
a bridge coupling the frame to the connector.

Example 155. The method of Example 153 or 154, wherein the moldable material is configured to adhere to one or more components of the auxiliary support to trap debris produced by fracturing of the auxiliary support.

Example 156. The method of any one of Examples 143 to 155, wherein the auxiliary is configured to engage with a dental appliance to maintain or apply a force to the tooth.

Example 157. The method of any one of Examples 143 to 156, wherein the auxiliary comprises an attachment, button, power arm, splint, distalizer, bracket, or wire.

Example 158. A device for placing a dental auxiliary on a tooth, the device comprising:
an auxiliary configured to be mounted on a patient's tooth; and
an applicator interface coupled to the auxiliary, wherein the applicator interface comprises:
   a first end portion comprising one or more breakable struts coupled to the auxiliary,
   a second end portion configured to engage an energy applicator, and
   a lumen extending between the first end portion and the second end portion.

Example 159. A system for placing a dental auxiliary on a tooth, the system comprising:
the device of Example 158; and
a dental auxiliary positioner comprising a registration element configured to receive a patient's tooth, wherein the registration element comprises a recess formed therein to guide placement of the auxiliary of the device on the patient's tooth.

### CONCLUSION

Although many of the embodiments are described above with respect to systems, devices, and methods for placing auxiliaries on inaccessible teeth, the technology is applicable to other applications and/or other approaches, such as placing auxiliaries on teeth that are not inaccessible. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-22.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A dental auxiliary positioner for placing a dental auxiliary on a tooth, the dental auxiliary positioner comprising:
a registration element configured to receive a patient's tooth; and
an auxiliary support coupled to the registration element and further coupled to an auxiliary, wherein the auxiliary support is configured to position the auxiliary against a surface of the tooth, and wherein the auxiliary support comprises:
a frame extending at least partially around the auxiliary,
one or more struts coupling the auxiliary to the frame, and
a flexible bridge coupling the frame to the registration element, wherein the flexible bridge is configured to bend in one or more directions relative to the tooth to adjust the position of the auxiliary on the surface of the tooth.

2. The dental auxiliary positioner of claim 1, wherein the flexible bridge comprises an elongate shaft having at least a portion that extends laterally away from the registration element.

3. The dental auxiliary positioner of claim 1, wherein the flexible bridge is curved between the registration element and the frame.

4. The dental auxiliary positioner of claim 1, wherein the flexible bridge comprises a first end coupled to the registration element and a second end coupled to the frame, the second end being narrower than the first end.

5. The dental auxiliary positioner of claim 1, wherein the one or more directions comprise a buccal-lingual direction, a mesial-distal direction, or a combination thereof.

6. The dental auxiliary positioner of claim 1, further comprising a recess formed in a surface of the registration element proximate to the flexible bridge, wherein the recess is configured to accommodate the bending of the flexible bridge in the one or more directions.

7. The dental auxiliary positioner of claim 1, wherein the flexible bridge is configured to constrain the position of the auxiliary on the surface of the tooth to a predetermined range.

8. The dental auxiliary positioner of claim 7, wherein the predetermined range comprises a set of locations no more than 0.3 mm away from a predetermined location of the auxiliary on the tooth.

9. The dental auxiliary positioner of claim 1, wherein the frame extends only partially around the auxiliary.

10. The dental auxiliary positioner of claim 9, wherein the frame comprises a first side coupled to the flexible bridge and a second side of the frame opposite the first side, and wherein a gap is present in the second side of the frame.

11. The dental auxiliary positioner of claim 10, wherein the one or more struts comprise a pair of struts positioned adjacent to the gap in the frame, each strut of the pair of struts is oriented at an angle relative to the auxiliary, and wherein:
(a) the angle is configured to concentrate stress at or near an interface between each strut and the auxiliary when the dental auxiliary positioner is removed from the tooth,
(b) the dental auxiliary positioner is configured to be rotated in a lingual-to-buccal direction to remove the dental auxiliary positioner from the tooth, and the angle is substantially perpendicular to an axis of the rotation, or
both (a) and (b).

12. The dental auxiliary positioner of claim 10, wherein the one or more struts comprise a pair of struts positioned adjacent to the gap in the frame, wherein each strut of the pair of struts is oriented at an angle relative to the auxiliary, and wherein the angle is a positive angle.

13. The dental auxiliary positioner of claim 10, wherein the one or more struts comprise a pair of struts positioned adjacent to the gap in the frame, and wherein an interface between each strut and the auxiliary is positioned occlusally of an interface between the strut and the frame.

14. The dental auxiliary positioner of claim 1, wherein when the tooth is received within the registration element, the auxiliary support positions the auxiliary at a predetermined location on the tooth.

15. The dental auxiliary positioner of claim 1, wherein the auxiliary comprises an attachment, button, power arm, splint, distalizer, bracket, or wire.

16. A computer-implemented method for designing a dental auxiliary positioner for placing a dental auxiliary on a tooth, the computer-implemented method comprising, by one or more processors:
accessing a 3D model of a patient's teeth;
determining a design for a dental auxiliary positioner configured to position an auxiliary on a tooth of the patient's teeth, wherein the dental auxiliary positioner comprises the dental auxiliary positioner of claim 1; and
generating instructions for manufacturing the dental auxiliary positioner with the determined design.

17. The computer-implemented method of claim 16, wherein the instructions are configured to cause an additive manufacturing system to fabricate the dental auxiliary positioner via an additive manufacturing process.

18. The computer-implemented method of claim 16, where determining the design comprises:
identifying a surface of the tooth where the auxiliary is to be positioned, and
determining a geometry for the auxiliary support that positions the auxiliary with a negative offset from the surface of tooth.

19. The computer-implemented method of claim 16, where determining the design comprises:
identifying a force applied to the auxiliary during removal of the dental auxiliary positioner from the tooth, and
determining an angle for at least one of the one or more struts based on the identified force.

20. A method for placing a dental auxiliary on a tooth, the method comprising:
positioning an auxiliary against a tooth of a patient by placing a dental auxiliary positioner on the patient's teeth, wherein the dental auxiliary positioner comprises:
a registration element configured to receive the tooth, and
an auxiliary support comprising:
a frame extending at least partially around the auxiliary,
one or more struts coupling the auxiliary to the frame, and
a flexible bridge coupling the frame to the registration element,
bending the flexible bridge to position the auxiliary at a target location on a surface of the tooth;
bonding the auxiliary to the target location on the surface of the tooth via a curable adhesive; and
separating the auxiliary from the dental auxiliary positioner by rotating the dental auxiliary positioner relative to the patient's teeth, wherein the rotating causes the one or more struts to release the auxiliary.
